(19) United States
(12) Patent Application Publication
(10) Pub. No.: US 2008/0046953 A1
(43) Pub. Date: Feb. 21, 2008

(54) iWiTTY TV Concept, TV-program- and radio-TV program production method / system

(76) Inventor: Pekka Juhani Kossila, Koh Samui (TH)

Correspondence Address: Pekka J. Kossila, 86 MOO 2 Bobhut, Koh Samui, SURATHANI, 84320, omitted

(21) Appl. No.: 11/497,709

(22) Filed: Aug. 3, 2006

(51) Int. Cl. H04N 7/16; H04N 7/173

(52) U.S. Cl. 725/132; 725/131; 725/140

(57) ABSTRACT

iWiTTY TV Concept, iWiTTY method of making TV entertainment and -Radio-TV programming are ground breaking new ways to put viewers in charge of producing TV- and Radio-programs. When viewer can become TV-producer at home it opens countless new ways to make interactions between TV-screen and viewer and creates millions of new program makers. Recycling old video footage is like recycling garbage. In order to get most out of it, it is way better to be put in a new useful use and save the nature. By editing, sending and reviewing the iWiTTY program clips people get to be in charge of what comes out of TV. Upgrading footage to broadcast quality from mainframe and only sending video in and -out points are clever way of playing down internet traffic. Viewers can truly participate in dozens of new iWiTTY TV-formats week on and don't have to queue up in rain or snow. Sex, race, physical disabilities or looks don't matter when people take part in iWiTTY entertainment formats. Everyone has one goal: To make other people laugh.

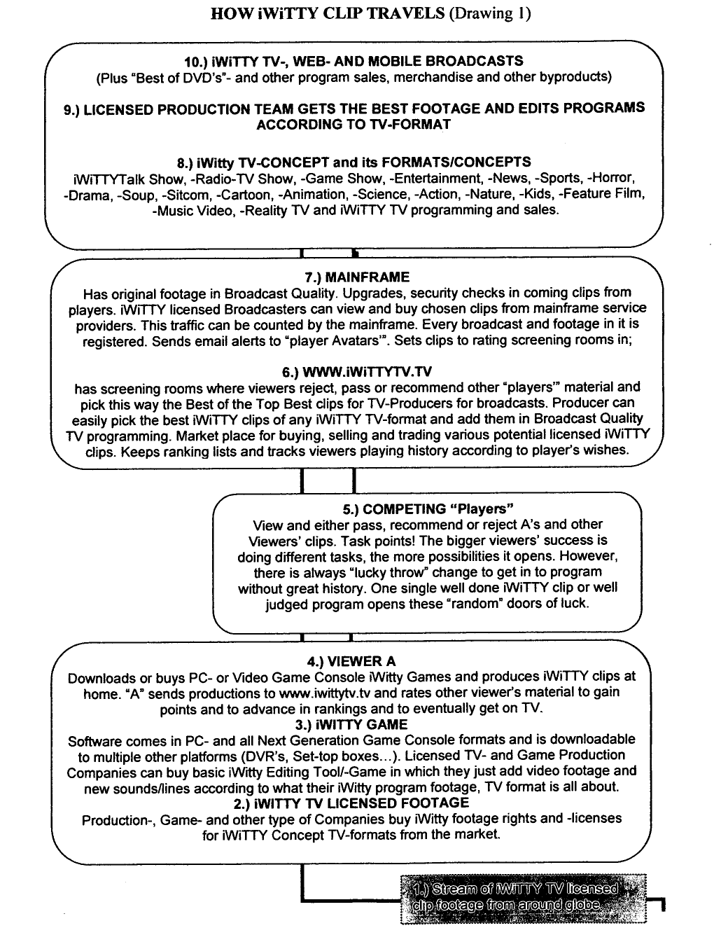

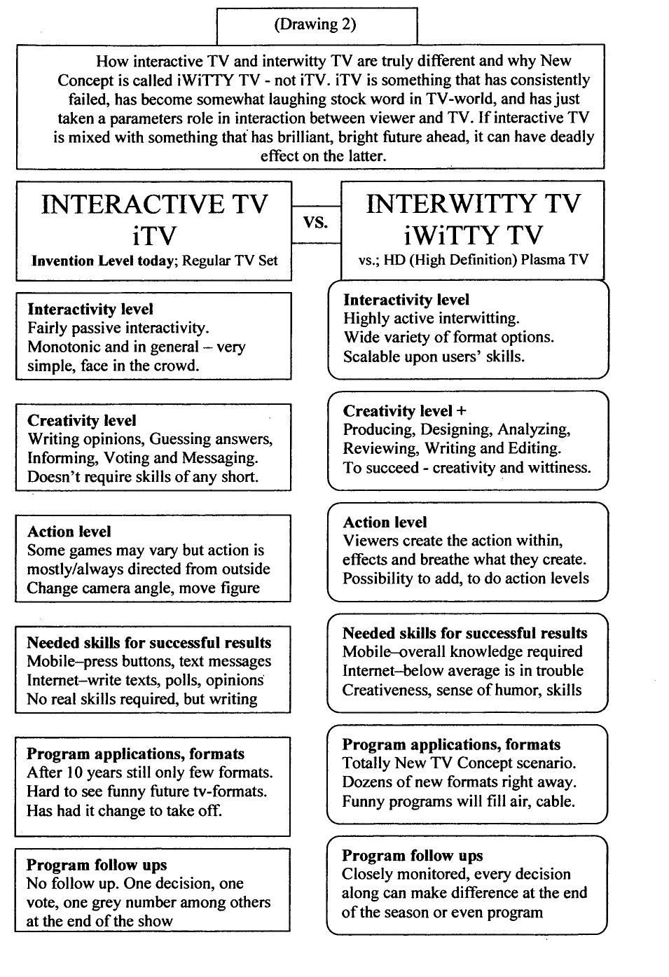

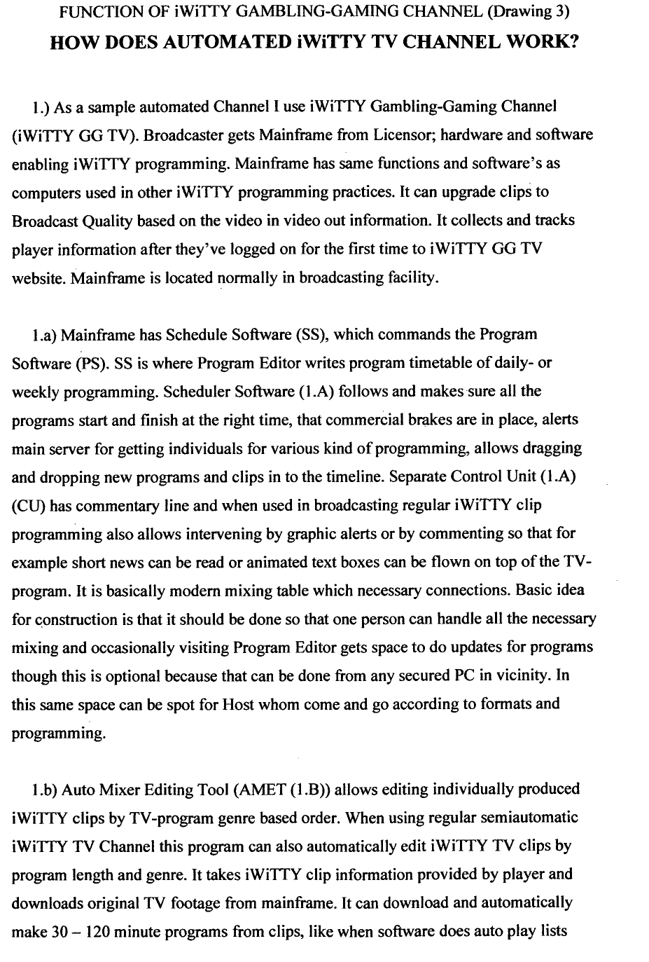

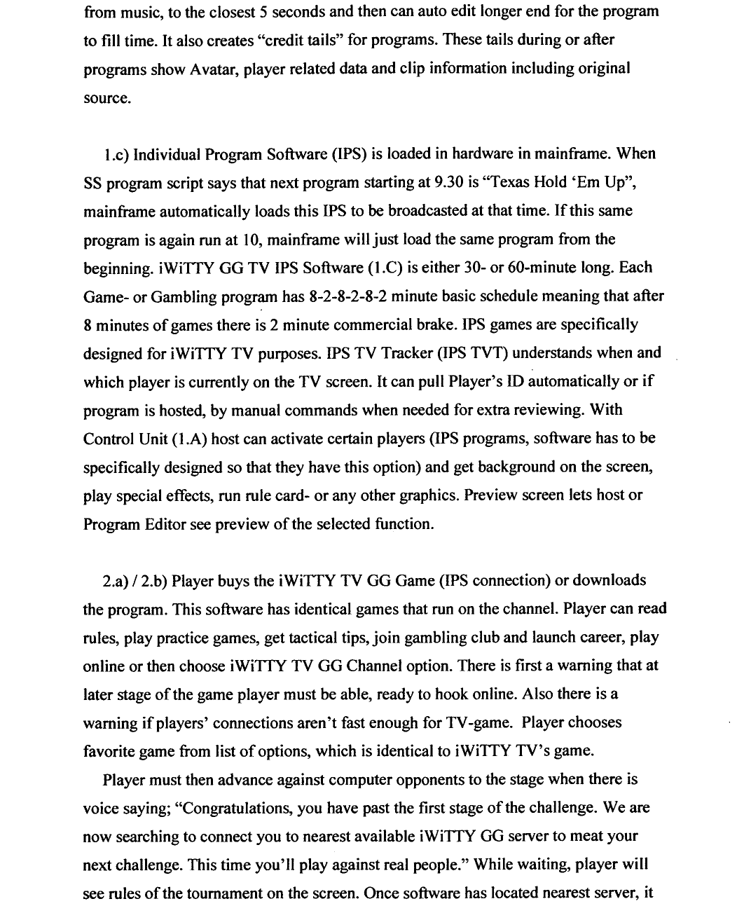

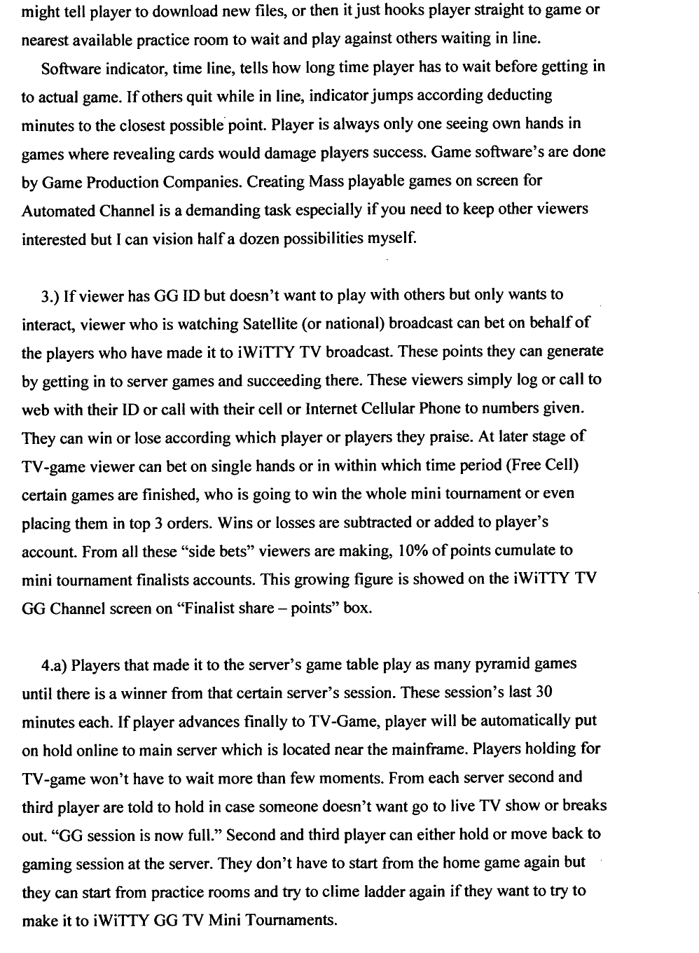

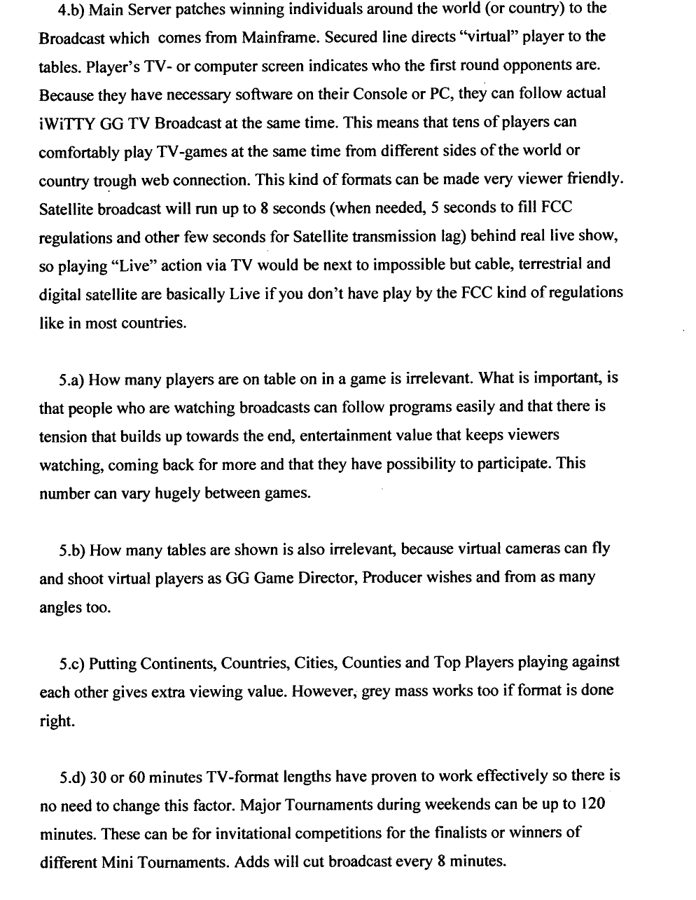

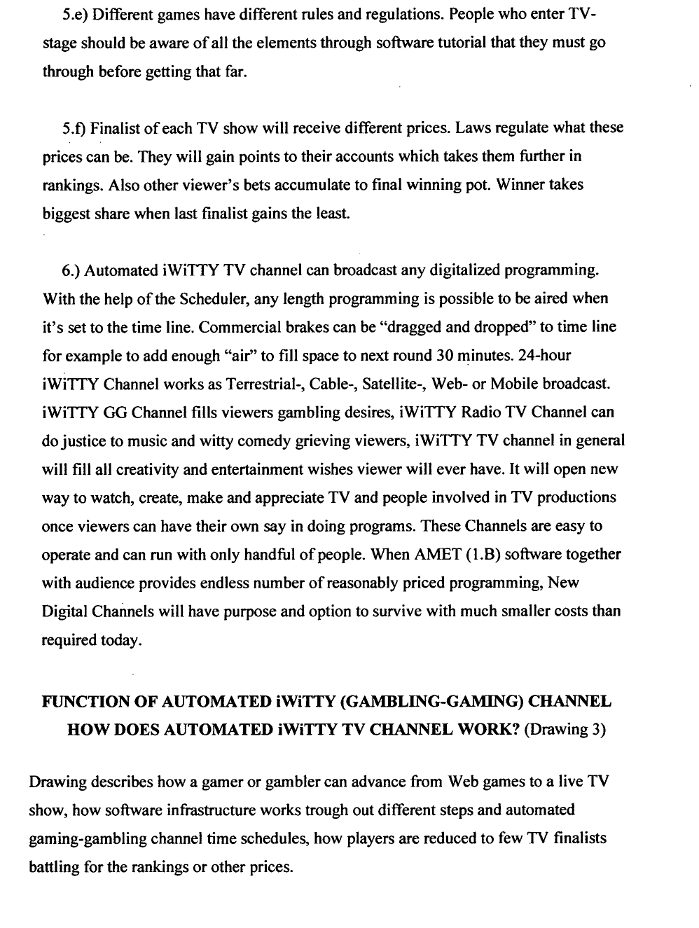

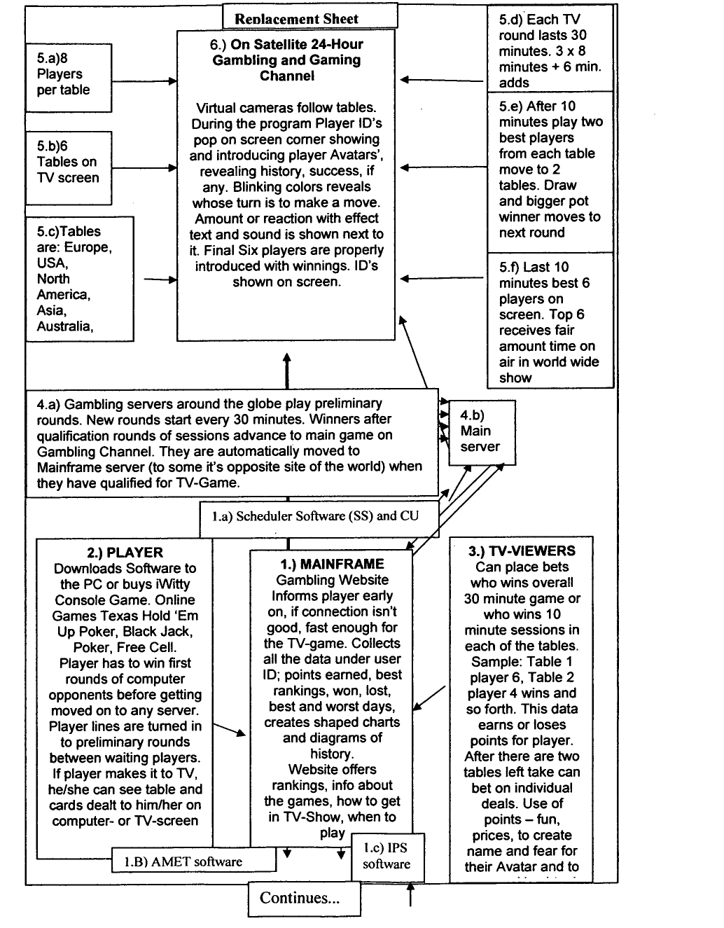

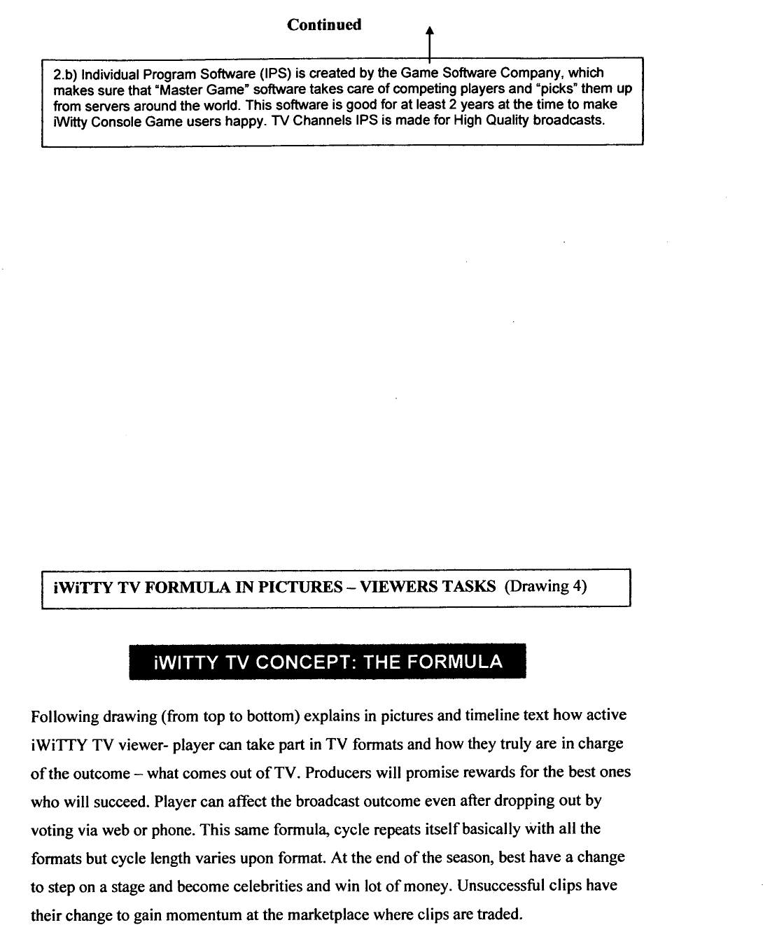

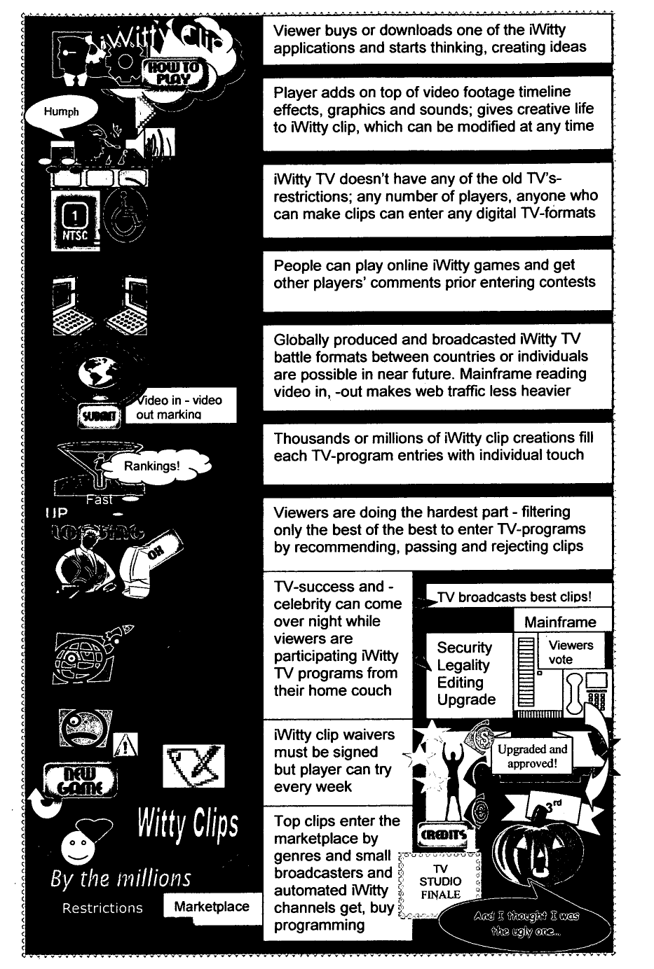

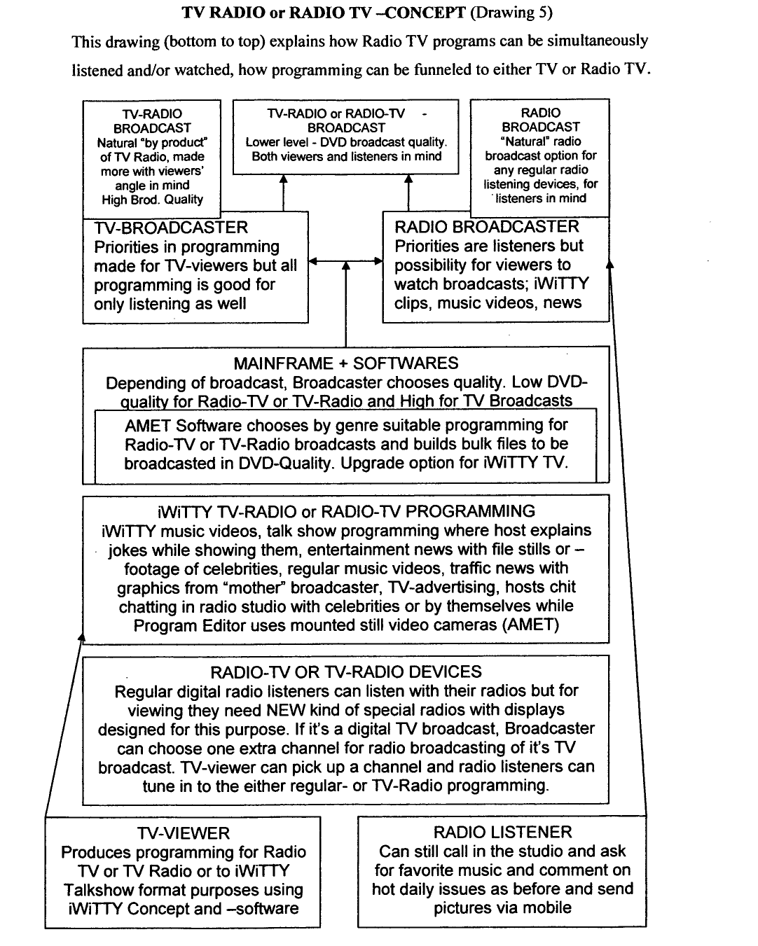

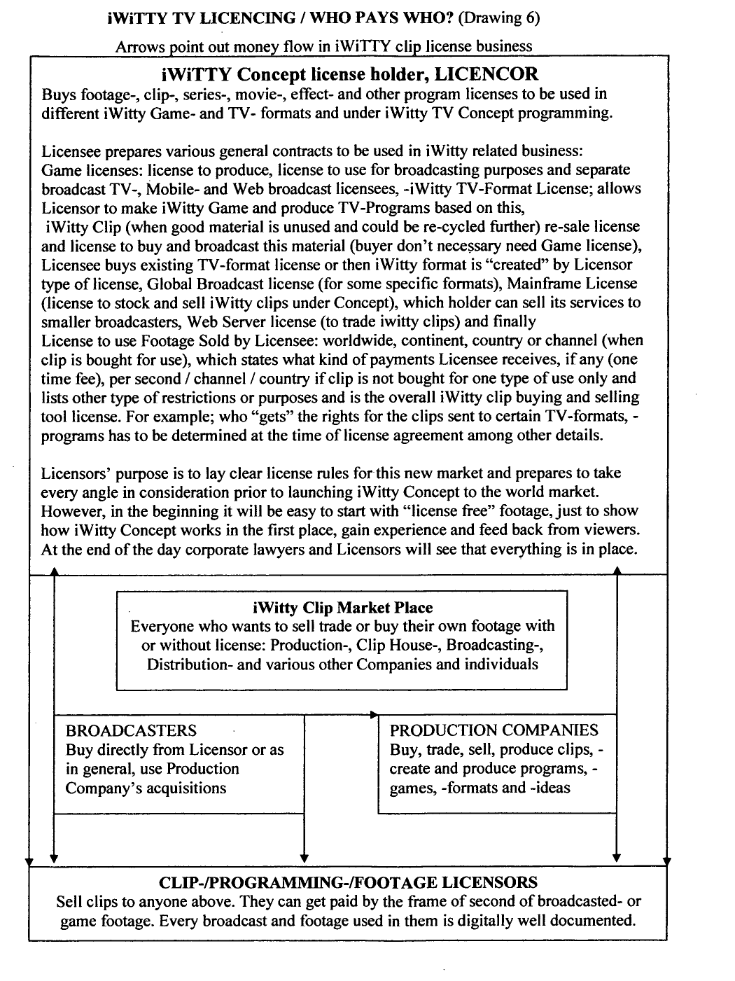

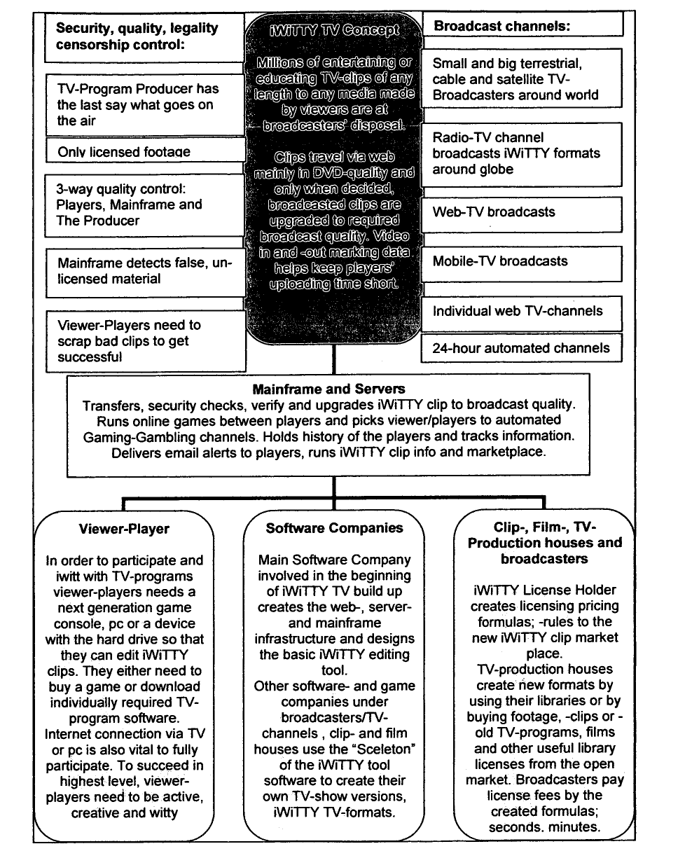

Final Drawing

iWiTTY TV CONCEPT:

How patent claims are in one same big package How
different parties, licensing, hardware and software
works together in iWiTTY world

Following chart should be read from bottom to top. Bottom boxes describe how iWiTTY Concept is born; format footages are gathered, “packaged”, licensed, sold and then edited by the consumers before entering the market. With software infrastructure in place people can enter TV formats, play online games that might lead them to TV finals or produce Radio TV programming. Products are monitored so that unlicensed material (Mainframe and Servers) don't enter market. Footage is send via web lightly (iWiTTY TV Concept). and different formats and programs are 3-way checked (Security, quality, legality . . . ). Different (Broadcast Channels) transmit platforms show numerous formats which use mainframe/server services to upgrade chosen licensed broadcast footage.

This invention is a new method/TV-concept to mass produce Broadcast Quality entertainment- or educational TV- and or TV-Radio programming much cheaper using existing program- and footage video clips making it minimum effort for Production- and Broadcast Companies by letting audience create, write, value, produce and choose TV-program clips.

### BACKGROUND OF THE INVENTION

### Prior Art

Before moving priority to television, I'll start shortly with radio and what are the current happenings in radio waves. Digitalization has multiplied stations and today it is possible for basically anyone who owns computer and is hooked to internet to start broadcasting digital audio. Radio's main function has always been to broadcast audio. TV-Radio or Radio-TV has been mentioned as a brief joke. Things are changing fast. There are certain laws that limit these radio waves but as in the past, rules change. What qualifies as audio broadcast? As in TV broadcast has radio broadcast quality jumped to new levels via digitalization. New methods of packing digital data have opened broadcasting options to multiple channels instead of one those old analog ones. This means also that more digital data is packed in to same space than before.

So today instead of investing millions in to a broadcasting unit, regular people can launch their own radio channels by having the smallest of equipment. And where is this going? In USA FCC has regulated this programming and during the past decades they've been chasing illegal broadcasters but since it's going to be next to impossible with multitude stations rising by the minute in digital world, there are most probably going to be new set of rules that are going to implemented. These changes are inevitable once radio broadcast quality can't be lifted any higher and things still must move on.

Actually digital radio broadcasts aren't just audio broadcasts anymore. In various countries radio program listeners have received traffic-, commercial-, music- and other data via the led or small screen of the receiver. Who says what kind of led or screen this can be? Could it be a screen of the size that of portable videogame players or driver's traffic advisory screen? If it was that size, why people couldn't broadcast programming for drivers and passengers to view.

One of the main reasons could be that it's expensive to broadcast TV-kind of programs via radio and other set of rules that regulate this sector. But if you would broadcast music videos that would basically be the same as listening radio just opening option to “view” music as well. Then again, would things be different if it's a TV that's a radio? TV broadcasters haven't probably given this too much of though with their own problems. Also making TV Radio concepts that are interesting enough for this kind of programming can be challenging and costly. Viewers could listen and watch most of the commercials as they are broadcasted on TV today. Listening ads is important criteria in advertising industry since almost 80% of people multitask while watching television. Whatever the reasons are new rules and regulations come and go so therefore one must be prepared to take on these new challenges. Now it's time to move on to television broadcasting side, which is absolutely the main course of this application.

When first Game Show-TV Concept program came to the screens and took viewers growing interest decades ago, every producer in business started to create or ask for entertaining and thrilling Game Show TV-formats. Somewhere along Sitcoms, Drama, Soup and other programming, TV-genres or with this type of programming less used word—TV Concepts entered the market. These were so called “not formatable” (although today soups, drama and sitcoms are sometimes sold to be made in other countries> for example “Office” program to USA, which is originally from U.K thus showing its formatting potential) programs. Basic definition in general for something to be a TV Concept is that its programming is formatable. Once any formatable program is scripted, anyone anywhere in the world producing TV-programs for living should be able to produce that program based on this script. Normally it is more complicated than this and many times consulting is needed, but that is the basic thought.

In the beginning of the 90' there was a strong view that “The” next big thing after Game Show TV would be Interactive TV, iTV. I was creating The First Interactive TV-Channel in Finland during last half of the decade. Creating interesting enough programming for masses with cost effective way became the biggest task of the Concept. Instead of gaining success alone, Interactive Program Concept melted into other Concepts and became interaction between viewers and program by simple ways. It became more like a tool or additional data screen added to various types of programs. Viewers reactions could be seen as numbers, vote amounts, percentages, requests or something more like a by-product of a Game Shows-, (Who Wants to be a Millionaire ask audience), Entertainment-, News-, Political Program- (polls, opinions), Sports- (polls, votes) or some Reality TV (votes) formats. Moving a simple amount of data as viewers' opinion about something could best describe iTV today.

Interactive TV didn't gain its own foot hold but is now part of various daily programs and also future programming. Earliest of Interactive Game Show formats were simply put under Game Show category like Danish “Hugo’, 1992—today, which has probably been the biggest success story of iTV so far. At highest peak it was broadcasting simultaneously in some 30-40 countries. In Hugo viewer uses phone to interact with animated troll character on screen via telephone dodging obstacles, jumping and going left and right. However, only one viewer could play at the time in a live show and all others would just have watch without interaction. This format still plays in some countries.

At the end of 90' A Swede created something that has ruled the Television for the past Millennium; Reality TV Concept. Unfortunately he didn't realize what he had done with his format what is known in America as “Survivor” when he created it and he couldn't see all the wide options it opened. Reality TV Concept name was invented later to put together all unscripted programming which started to pop up under this new category name. Today there are tens of Reality TV shows and although its success has likely peaked, it is going to be around for years to come and more and more channels are going to be concentrating on this cheaper production style because of the financial reasons and occasional success stories.

To come up with a successful TV-format isn't easy task at all, but is has been even harder task to create a new TV Concept. In fact it's proven to be impossible. Why no one has ever created a new TV Concept? When you are small- or big time Producer, you don't really care so much of the really big Picture when you're struggling to come up with a successful TV-format in a first place. All little details and elements of each production chew creative time and effort ever even letting main brains to take a breath and trying to figure out the big Picture. And once formats (generally 2-5 years) life is coming to an end, meanwhile there has been an endless effort to try and create some kind of new success format. Why bother to waste time to figure out this big Picture because it seems obvious everything is in place and all the Concepts are already invented?

Executive teams, who are the ones setting strategic plans for Networks for years to come are trying to figure out the future because it is in their strategy to try to know or guess what lies in years ahead. So far none of the have come up with a new TV Concept. This is simply because they usually lack the creativeness and experience needed in something as complicated and visionary as putting together whole new Concept Category.

To come up with something that really makes sense and is something completely new from previous Concepts has proven to be a job that no one single person or group of people have been able to complete.

In TV world it's hard to protect formats. Formats are like paper clips. You use little different material, shape, color and size and you have your own paper clip design, meaning your own TV-Format with a little different outlook. Usually Broadcasters don't dare to copy directly someone's TV-format presentation unless it's been based on loose idea like what FOX did when it took its Boxing program to the air. It only proves that if you give your TV-idea to a Broadcaster or Producer, they might just thank you and modify your idea and rob you by using “their own previous idea” which has been sent in by other format inventor and slaughter your sale to other network. TV-format people hardly even consider possibility of patenting TV-formats because they are such a loose commodity and only protected by the “Gentleman's Club” which FOX broke prior to when “Contender” aired. It's unlikely they'll do it again because of all the bad publicity and ratings their Boxing Show got.

Still who ever has a format idea is not really never sure if idea is just going to be taken, best part of is used or then format is slightly modified and Broadcaster or Producer claims its their own since they get tons of unsolicited material. They do get hundreds of format ideas yearly so it is not too hard job to put one and one together.

Surely the people who in the beginning brought to the world the first Game Show TV or Reality TV could have or should have patented their Concept because at the end of the day, they were the ones that invented The Paper. Without The Paper there wouldn't be use for these paper clips. Of course again, they should have known that they had actually invented The Paper, The Original Concept, name it, and then laid out its claims and filed in for a patent.

Survivor is mentioned almost as often when there is talk about when Reality TV Concept was born because others copied its basic success formula: 20 or so “players”, bunch of various competitions or tasks, occasional surprise element, voting by competitors with explanation of their choice and then finally player or players are dropped out at the end of the of the program. After Survivor's surprise success regular viewers were brought in front of cameras battling in variations of other Reality TV-formats and at the same time also “Peep TV” was born. I would use this term for programs such as Big Brother, Being Gotti or The Osboume's, where tapes run mostly just to shoot footage of celebrity people and best unscripted material is “attached” under so called “theme” and aired for viewers to peep at the privacy of their home. How celebrities day goes by, what do they do that's shocking, funny, meaningless and what kind of language they use, comments they say about things and so on. However, Peep TV term is never used but they are all under the Reality TV Concept (unscripted TV).

This could have been totally separate Concept but which little producer who has just sold its series to a broadcaster and to press that has named it as Reality TV, would go and file for a patent for Peep TV? Again producer, format inventor should have seen this difference between Reality TV and Peep TV (name) and understand the big picture instead of being busy producing programs. Surely these different Reality TV Concept genres compete in different Emmy categories but that is something no inventor had a say about. Survivor format inventor couldn't see the big picture, all the options his invention brought to the world and just stood by when others started robbing and creating the idea.

Game Show- and Reality TV Concept inventions reflect to our daily lives in many ways. World wide daily or weekly programs that capture viewers mind for brief 30 minute run. There are tons of by-products from these program genres which sell huge numbers and yearly profits are huge, global numbers. New millionaires or smaller winners are done on daily, weekly or monthly basis. World wide Idols are born to captive magazine reader's imagination but who really would have deserved honors and royalties from licenses hasn't been able to step out.

Today all the TV-Executives are baffled how they are going to survive in the future when media shatters even to smaller pieces. When I was creating Interactive TV-formats back in 90' it was really hard to see how one can do really entertaining programming for bigger audiences using iTV Concept. I quit the Company just before year 2000 because. However, I had a vision already that when technology advances enough there are going to be options for a New kind of Television Concept. Biggest lesson learned is that Next Generation people want to be more in focus and part of something or at least have that slight possibility to get on stage. Next Generation also wants more creative level of participation. Just pressing buttons brainlessly doesn't give enough satisfaction for the videogame/internet generation. Blogging is one very good sample of how even news sector feels the pressure from ordinary people.

If one looks at the videogames offered today, person can understand that today's interactivity is to hook up with next to real looking video game characters and start smashing, racing, shooting, flying, fighting or then just laying back and watch when someone else does this.

Why should you line up hours and hours to get an audition for a Reality TV show and spend your valuable working time and money doing this? Still one would love to be on TV. Ask any audience who wouldn't want to be writer, producer, creative, director, editor or participant in a TV-show? Hands that are left down are for sure less than 20 percent of any audience—anywhere in the world. New option will give that remaining 80 percent change to make their dreams come true and take control over entertainment for once and all.

In the past these great Concept inventors have settled happily to see how their individual TV-format programs have been doing instead of gaining and pushing forward The Big Concept Picture. Their individual thinking has not reached that level where they could see tree as well the forest behind it. Press and TV-industry people are the ones who have come up with New Concept names, terminology and specifications for each of these Concepts that these little paper clips, TV-format flows have created.

It is almost like there is unspoken rule that format creators, -inventors and -producers must bring their collective effort to this huge bowl from which the industry and press then molds sub-products that are in their liking. They have created Emmy- and other Awards and divided genre categories by the concepts. They have created terminology and standards they have laid the rules of. If Reality TV Concept would have been actually created and patented fully by an individual, what are the chances that this individual could have told industry people to add this New Reality TV Concept to their award categories? Maybe chances would have not been too good at the beginning. However, free market world works surprisingly well and once something gets big enough, it changes all the prior rules.

If one would stand up today and state that I have a New Concept, Industry would be in a shock. Speculation that there would be a TV Concept, which always requires downloading or purchasing software in order to fully take part in its programs and that couldn't possibly be same than any other Concept today, would be a new one, right?

Would TV-industry scream; How could this happen? We never even heard about this! It can't be done! We are the ones setting rules. Not the paper clip people.

TV-industry would not nor will not like this person who would beat them in their own game and create new thing without their “permission”. That someone would invent something so big and complicated that no one else has done before. They would rather see people adding these paper clips in to that big bowl of theirs which they can then control and mold. As a former TV-format inventor and -creator I say it is time to change this kind of community thinking and give all the credit to the ones who deserve it.

Concepts can be created by an individual or group and I have worked long and hard to prove it. Finnish PTO search found in February 2006, 2 somewhat related patent applications and one patent (I filed for funding from Finnish Keksintosaatio to finance filing this application entry and they sent my application as it was before double checking to Finnish PTO and finally got it) that I looked and that are different:

US 2005-0262526 A1 which is a fee based interactive television that receives and displays view-submitted materials, US 2005-0152666 which is a system and method for automated editing of content and A1 US 2001-06320600 B1, which is a web-based video-editing method and system using a high performance multimedia software library.

### BACKGROUND OF THE INVENTION

### Objects and Advantages

Instead of explaining all things in past many ways down to detail, because this application will be long even without TV's history and present which everyone can see by switching on TV set, I will explain future and concentrate on things that future holds, how my invention betters and is different from past and present interactive TV and other present Concepts, that it is arguably its own New TV Concept, how it makes quality productions faster and easier than ever, how it cuts production costs, how it lets viewers in to the production process of TV-entertainment, how viewers will be able to make up TV-programs at home, how it functions and how Viewers, Producers, Broadcasters, Game Production Companies, small and big TV-Stations, License Holders and finally Environment benefits from my invention.

What is the future of the Television is often asked question. And here's the answer:

TV's future and New Concept is going to be bright when viewers are brought in to level, downsize, change, improve and attack in to all of the following problems:

Costly productions, lack of creative minds and skills in writing the scripts, time consuming costly editing, traveling for productions, hiring lots of expensive personnel; actors, producers and staff involved in productions. How to catch viewers or video game players short interest span and their growing focus on New Media; Internet-, PC-, Next Generation Video Console- and Mobile Games and how to make more, new, different kind of Interactive Programming prior today and combine it creatively and efficiently with other existing Concepts and throw New media in the mix? How to make entertaining- or educating-, affordable TV-formats that answer to entertainment-, production- and broadcast quality demands of ever expanding and exploding New Media-, Cable-, Satellite- and Terrestrial broadcasts at the same time saving energy, materials and environment by less consuming production ways and still at the end come up with top quality entertainment?

From viewer's point of view less time is spent in program casting lines, on traveling and less money is spent on these time consuming matters. Racial and physical issues are in par with the New Concept and its upcoming TV-formats because no one knows who the people really are behind the productions until winners are filtered through rankings or by other types of methods. All kind off racism is zeroed down along with “beauty” and producers “wish” lists. This means also less stressful, all equal way to participate TV-programs. Concept offers new creative ways to play a part in TV-programs without necessary buying new hardware. Only thing that matters is how creative, witty and active viewers are. Watching TV is as easy as before but after New Concept gets on the air viewer will have a new option; do I want to produce part of the TV-program and actually be part of the program or do I just want to watch it?

1) iWiTTY TV Concept will use existing software makers skills and hardware and it's not dependable on future technology even though it surely will make it even easier to adopt iWiTTY TV Concept and create its ground breaking way of doing programs. Bottom-line is that everything in Witty TV Concept is doable today. Software is a key factor in this TV Concept that will shape TV's future. No other existing TV Concept is based on software that the viewer must get before participating TV-programs. That is the main reason why it is all different. And because it's all new and different it can't be the same than something existing. Mixing past and future terminology of television together does not work with the New Concept. By this I mean mixing past interactive TV with future interwitty TV.

“I” stands for “Interactive” and “Inter”. Combined it with witty, it means interacting in a witty way and loose term for iwitty means: “I'm witty, -clever”. Since this word doesn't yet exist in general use, or anywhere else that I know of, here's the definition for the dictionary. This word is used a lot in this application and is very important element, almost vital for the Concept as Application Examiner will later notice:

Verb to interwitt (to iwitt, to iWitt); to smartly, cleverly produce, make something useful, entertaining or educational out of existing data, information, music, videos, films, videogames or sound effects that would otherwise just stand useless or in little use for its potential; to put little used data in re-circulation; to recycle data for entertainment or educational purposes; to give new entertainment value for old data

Person that does this is called interwitty, iwitty, iWitty, and present verb—“doing iwitty work”; interwitting, iwitting.

Since improvements and sequels often come in bigger numbers, bigger letters, multiple letters, iWiTTY's two small i-letters emphasize that fact. It may sound too great at this time of the application. However, definite improvements iWiTTY TV will bring to regular iTV and changes it brings to existing concepts back the word and even how it's written.

2) You can't do iWiTTY TV Concept or -programs without new software products, iWiTTY Games, which is one of the reasons why it's so unique. The Second main factor is that the public, audience, are the ones making the hardest, most time consuming part of the iWiTTY TV programs; creating, scripting, designing, editing, mailing, reviewing and either rejecting, passing or accepting program parts, clips. Audience, public, viewers, players, participants are the ones that use their time, money, effort, creativeness and wittiness to produce these entertaining- or educational TV-clips or -programs.

3) Third main factor is used material. Although material given/distributed/sold to the audience could be bran new (5*), main idea is to recycle footage and it's already in a form of any film-, video-, videogame- or still pictures that exists or will be transformed in digitalized form. News-, sports-, nature-, action-, adventure-, sitcom-, drama-, talk show-, game show-, horror-, document-, feature-, reality TV- or basically any general video- or film-footage or still pictures work as well as the next ones under different iWiTTY TV-formats.

To put it simply: Every picture, footage or sound of any kind can be used with in iWiTTY TV programs as long as it's digitalized. No footage has to be necessarily shot or done specifically for iWiTTY TV use. Aim is to let public come up with as many possible outcomes from given materials on their own. However, this doesn't close out new material. Simplest way to describe iWiTTY TV is this: One clip—million different outcomes.

4) To upgrade digital footage from lower level quality to TV-broadcast quality, it needs to be in broadcasting quality in the mainframe. This means that main computer holds all the original video information, data of the given/downloaded/sold footage and runs software programs. When mainframe identifies user log and accepts sent legal material from a legal user, if necessary, it can upgrade this material to broadcasting quality by using the same codes in software as in its memory in broadcast quality. This means any original digital footage that it holds within its memory bank it can replace lower incoming digital footage just from video in video out spots.

Sample: Player “A” buys a software program and uses three different clip parts to make the finished production. A's clip order is 1100, 1000, 1200. Mainframe reads this and understands to build this in right order from its original high quality source material it holds in its memory, so it only verifies this information by showing lower quality version of it to A and downloads the music, sound effects, comic bubbles, shout information or any other info, data that A edited on top of the production. Instead of sending top quality footage over the slow internet line, A is done with uploading the production within seconds rather than minutes or hours. Broadcaster has a chance to get hands on A's production in the highest possible quality in case it succeeds and Broadcaster wants to put clip on the air. This information can be stacked in front memory of the mainframe so that it produces the broadcast quality clip only if it's ordered by the Broadcaster. It could be even a small TV-station or private individual in the future, who orders these finished products: fully re-edited entertaining or educating iWiTTY TV clips.

5*) For newly produced footage there is going be plenty of usage too. In iWiTTY TV-formats use of this material is in viewers, players' hands. Video footage could be shot against “blue screen” (which usually is green chrome key background paint, curtain or mat that enables adding anything to the background) by the iWiTTY Game TV Producer. Loose script tells what kind of footage should be shot. Basically any footage shot can be added in iWiTTY Game. This is the kind of footage which is giving program genre only basic directions and viewers get to make the end results as they please. Readily shot mixed clips have options from extreme close ups (footage shows only eyes, nose and mouth) to wide shots were actors act like in most movies today filled with special effects. Actors act different motions (surprised, happy, sneaky, in rage . . . ) in several of situations to be then edited in to iWiTTY Game. Wider variety of shots is giving plenty of options for “players” to modify exponentially outcome of each episode. Same, easily made material can be used to make 2-5 (or endless number) of TV-episodes instead of just one when it's in short bits in a iWiTTY Game and player can add background, sounds, effects, bubbles and other elements almost endlessly upon choice.

Drama-, Soup-, Sitcom- or Reality TV program is done by actors or by ordinary people as in ordinary productions (blue screen background), but involves mostly just mouth movements without any specific lines. Here people can pick up spoken lines, murmurs, dog barks or what ever that is in the iWiTTY game Editor sound library. Using iWiTTY Game (which always comes with Editor software) Editor Software, “Player” can then edit from wide variety of options, what's on the background of each shot from Hawaiian resort to mountain top or bicycle store to Empire State Building or just that home mansion where the whole thing supposedly takes place. This way not only do the viewers watch the soup but decide location, lines and storyline.

Each iWiTTY Game is an individual game and footage and effects from different iWiTTY Games can't be mixed together unless they are same program series, so it is up to the actual iWiTTY Game Producer, what kind of footage is shot, produced. And this is based on what type of iWiTTY TV-format Producer is offering to players to make.

One part in this TV-genre is that the footage can be shot in different countries at the same time. It is just collected, edited and produced in to iWiTTY Game application. Once basic “blank” iWiTTY Editing Tool is on the market, it's easy for Production Companies just to add New Footage on it and these decisions are based on what type of iWiTTY TV-formats they are going to make. Instead of making New Product each and every time, iWiTTY “Game”, Editing Tool remains mostly the same through out the years and just actors, video clips shot, acted and spoken lines, shouts and other “minor” factors change from iWiTTY product to product.

This “blank” iWiTTY Editing Tool application is meant for sale for Production Companies involved in iWiTTY TV productions. “Players” that buy or download individual iWiTTY Games can then add comic bubbles, sounds, shouts, comments, lines, music, stills, murmurs, photos and various other effects to the video and soundtrack to produce their own video art work, iWiTTY clips. Original high quality footage of this usually DVD-quality iWiTTY Game is stocked in mainframe memory and used in this kind of iWiTTY TV programming to downplay heavy internet traffic and upgrade iWiTTY clips to TV-program broadcasting quality.

Formats are numerous under these conditions. In some formats actors can actually act and say from few to many “bunch lines” which have to be used in certain part of the program of certain episode and even in certain order making a “skeleton” for this type of iWiTTY soup genre. This way there is an outline that pushes these series, whether it's Drama-, Soup-Sitcom- or Reality TV, to certain direction. In this genre series actors do all the optional lines, shouts, comments, murmurs for the people to add from their iWiTTY editing tool, iWiTTY Game. They can belong to the right face or not depending if it's originally Sitcom-, Soup-, Drama- or Reality TV program. Meaning that face and whom the voice really belongs to is in players' hands when they are producing these clips. Donald Duck's voice could belong to Al Gore.

When you remove blue screen option from the production background, you can still do all these options same way, but then player doesn't have option to modify background. Player can still however do all other modifications and editing options as previously mentioned and use technique to build anything from 10 second clip to full 22-24 minute sitcom if it is the purpose of that iWiTTY TV-format. This is always possible to be broadcasted in highest quality since original footage is in the mainframe.

To make sense selling for example million units or downloads of the “same” episode as iWiTTY Drama Game and have option handful of them ever be shown on the air, there has to be other tricks and purposes as well to buy these products. There is always iWiTTY online Game option as well as “home game” option included in software. iWiTTY licensed Web TV Channels specifically dedicated for airing clips are also natural option to show these unaired episodes. DVD for sale with best clips in it, where everyone who made a clip receives a price (points, ranks, levels or even cash) is other marketable way. To make whole season of TV-episodes from 1-4 iWiTTY Game DVD Production Package is considerably more interesting and affordable from viewer's point of view.

This style is surely cheapest way to produce any of the above products—besides downloading options. It makes no sense for anyone to start editing last episodes of the season first because no-one knows how any iWiTTY Drama-, Soup-, Sitcom- or Reality TV story will move on. They will have to follow up on weekly basis what is happening in the aired TV-episode and right after that make their own version of the next episode. They can just edit also just one short clip suggestion, 10 seconds to 60 seconds to be added to the next aired program. Channel can broadcast “patched” TV-program in prime time and in other time slots they could air other versions of the program. Downloading is more up to date option because new kind of twists can be offered as storyline moves on. All clips are made and approved by viewers.

This genre of programming can create various types of iWiTTY Channels—“Powered by Viewers”, where all the programming is done by viewers. Viewers will not have any license to any of the footage they have sent. Signed waiver upon signing in as an iWiTTY Game participant will take care of this.

6) Phone and web has been long part of interactivity in TV-programs. iWiTTY TV betters other existing forms. Idea that I got already six years ago has finally come (technology) to the stage which allows Next Generation interaction in this sector as well. Viewers who are watching TV can take their internet mobile phones and use it as a “remote” during any iWiTTY or regular program with one cheap call during the whole show, or they can use internet instead.

At first A dials the number on TV. Lets say A wants to participate “The” Producer iWiTTY TV program, and gives personal code, which A got as he logged on for the first time to the iWiTTY website. Now computer knows that legal user A is using this number. A does this to get more “credits” to his account. All decisions that A does during the program will then effect his account. A can also put this number in his mobile' fast dial memory so that next time he only presses number 1 and his speed dial puts him directly “in the show”.

Mainframe understands that A's calling and credits his decisions. Decision credits end up directly to his account. So after the show A can check account on the web and see how rankings were affected by the results A made during the program (A could also win individual prices during the TV-program). Player could also order automated Short Message to mobile phone. This message could come every time after player has used mobile to participate iWiTTY programming telling ranking, player score from this effort and various other information. This way player can be part of Massively Multiplayer Online Games (MMOG) which connects TV-Program, Internet Cellular, Internet, even individually sold and Online played iWiTTY Games for PC or -Video Game Consoles in to one huge MMOG. There everything you do effects to your results at the end of the day.

7.) Automated and semi automated iWiTTY TV-Channels can run with small, few people staff. Basic idea is that the programming is Powered by Viewers using iWiTTY TV-Program Production Method. iWiTTY TV Channel chooses its programming strategy and then buys iWiTTY TV programming from the open market: iWiTTY-Talk Show-, -Entertainment, -News-, -Sports, -Horror, -Cartoon, -Animation, -Action, -Nature or -Music TV. These are so called left over iWiTTY clips from other Broadcasters who didn't find any time, use or space for the good non-broadcasted iWiTTY clips. Highest rated clips that are left over from productions can be edited or just auto “patched” by software through internet into mass production programs. iWiTTY clip after clip with “player” ID at the end of each of these clips or at the end of full program appears showing who made it, from which original TV-program or -programs clips were taken from and even when the clip was made. Each one program on the iWiTTY Channel can consist of any amount of different clips without host explaining or studio audience clapping in between them.

Channel can also choose to produce its own iWiTTY TV-formats and show them. Function of semi automated Gaming-Gambling Channel, which is explained further down in this application, is different. Channel showing just iWiTTY Clips functions differently because there's no direct interactivity with these programs. Software just “packages” different iWiTTY TV-formats' iWiTTY clips under different previously mentioned iWiTTY genres and broadcasts them in the order made by Scheduler Software (1.A) (SS) program. This is software where Channels' Program Director can write the order and times when which program will be broadcasted. Programs are 30 to 120 minute formats. In between programs there are commercial brakes, which will be inserted to the programming so that clips don't cut from the middle. Commercials will be packed in 1 to 3 (generally) minute blocks and once determined in which time slots they need to be put; these blocks are “dragged and dropped” to the Scheduler Software (1.A) time line.

How does iWiTTY TV work? TV Broadcaster that wants to run iWiTTY programs as a part of its programming or fully needs to get its own Mainframe, with massive computer capacity and Server computer to handle heavy incoming internet traffic. Or then they just buy service from someone who has it.

If it chooses to attach cell-, land phone- and internet call services, extra additional smaller capacity separate Mainframe for this use, mainly for stability and security reasons. Many stations have this capability already today but due to software infrastructure, compatibility and security reasons it's likely they'll have to get these both unless they just want to buy service from other Company.

Any of the above mentioned digitalized footage stands in the main frame computer in broadcast quality; MPEG 3, MPEG 4, HD (High Definition) or even higher (in future) depending on TV-standards required in that country, area and type of the TV Broadcaster. Smaller TV-Stations can also buy services from other, bigger TV-Broadcasters or from any Licensed Company under their terms.

Sample 0: Viewer A goes to a store and buys a PC-game, future DVR or Set Top Box (can hold simpler or full version of the editing program) or downloads necessary program, Sony PlayStation 3-, XBOX 360-, Nintendo Revolution- or any new Next Generation Game Console game and A can start producing own little productions for the Television. In iWiTTY Game (I call these editing tools and given footages iWiTTY Game-series) there are 3 levels (or more) of editing tools in which first one is tutorial and easy editing level to get started (For Kids iWiTTY Game-series there will be separate iWiTTY Editing Tool with easier interface and less functions).

Second level is intermediate level that allows player to register (through web) and send 10 second (or any length) finished production trough the internet for the other people to view and compete for success. iWiTTY TV Mainframes/iWiTTY Game Server locations are the registration locations. Intermediate level means also that it doesn't allow hardest level of editing tricks. Once player A sends clip through the server to mainframe, it can read the code of the final edited video footage. It picks the codes of the video but instead of downloading all this information, it builds video footage timeline itself from incoming “video in-video out” information from its original footage adding or downloading only A's other than video footage data on top of this. Other added effects, graphics and music data goes on this timeline and is the heaviest part that servers download. So if A added text or sound effects and mixed the video footage order, mainframe only downloads this information on top of its existing information about the video footage which it has mixed from the original material that it holds in its memory.

This means that instead of sending this video material to its full scale over the internet, it's only sending information about original video footages' in and out points. When and if A's production ever makes it to the show; it's in mainframes memory ready to be outsourced, broadcasted or transferred in highest possible quality. It can also provide right broadcasting level files for internet viewing so that people with faster connections can look better quality and those with slow connections can see less time consuming quality or size of video.

Third level of iWiTTY Game editing tool is then for the semipro editors whose finished clips are more advanced and uploading and downloading these clips will be more time consuming.

Most time consuming part of these “send your opinion, -footage, -joke or -suggestion to our program” (unsolicited material), is to go through all thousands and thousands of solicited materials (which is why TV-channels hardly ever use them. America's Funniest Home Videos despite often very bad quality of the footage has been successful doing this) and this is where in iWiTTY TV Game players do all the hard work.

They reject, pass or recommend other players clips by reviewing them at the web screening room. After going through rounds of viewings and acceptance, in a case of success, the very best of the programming ends up to actual iWiTTY TV-program Producers' table who then decides from selected number of the clips the ones that make it to the actual TV-show. Numbers of acceptance rounds are higher with the most popular programs since they likely get much more material.

At the end TV Producer and the team members decide how many of the very best they want to view of each episode and finally which ones get added on a program. This already means that all these “clips” are widely accepted by the general audience and that they also qualify by other terms. This means length-, quality-, legality-, censorship- and entertainment (or educational) value wisely.

To make sure other viewers viewing player A's clip take this task seriously, other viewers gain points, ranks, prices or levels for their Avatar. Avatar is something player creates when she/he enters the iWiTTY World on the internet for the first time. Under Avatar viewer has nickname and images but also all the necessary real information; name, address, age, e-mail address and phone number of the player so that in a case of celebrity is calling, she/he can be contacted. One player one avatar one program type means that tactical or other kind of messing with other viewers' productions will leave a minus mark, negative trace in their iWiTTY Game history which is important safety measure and good way to keep viewers interest high. If clips is bad quality, basically should have been censored type of clip ends up in TV-Crews desk, viewers who recommended these clips are “punished” by minus points accordingly.

Clip's viewer-producer wants to be seen, so for broadcast editor software (AMET (1.B)) automatically creates TV ID tail of each clip with detailed data. These end tails could come in three versions: Long (about 10 s) reveals all this data together with original program details, Regular (about 5 s) version cuts out player history but shows best achievement and Short (about 2 s) just flashes all the details legally necessary. These “tails” can be shown after each clip, after or prior to segment or then at the end of the program.

E-mail- and SMS (Short text messages via cell phone) alerts will keep players up to date when they need to do for example viewing tasks to gain more points. All this work is automated. If they choose clips that don't have any success they'll lose points and that way are further down the line to get their own productions on display, on the air.

Let's pretend that player A made the cut and A's “clip” is on next days show. In the morning Producer's assistant has all the 50 best clips production team wants to view at his/her laptop in DVD quality downloaded from the mainframe. TV-production group views clips and decides which clips make the cut and in which order they should run. Assistant then makes a list and downloads original clips to broadcast units' mainframe (if they buy the service) or just orders them from mainframe in right quality to a laptop or pc. Mainframe then produces “video in video out” from broadcast quality video data and adds the “effects and sounds” soundtrack layers for the finished product and uploads clip files. These clips are then run in a “Live” or “Taped” program according to clip order decisions and iWiTTY TV-format.

Sample 1: With the iWiTTY Concept Individuals can create, or edit easily iWiTTY comedy clips and fight for the title of “THE” PRODUCER (full sample of “THE” PRODUCER formats is explained later) who will have to go through a tough battle against tens of thousands other producer wannabees and compete for the audience ratings and votes whilst managing their talent, taste, writing-, scheduling-, editing- and entertaining skills. Using iWiTTY Game footage libraries of various document-, sports-, news-, footage-, sitcom-, drama-, action-, adventure-, film-, cartoon- and other clips they add comic bubbles, sounds, shouts, comments, lines, music, stills, murmurs, photos and various other effects to come up with crowd pleasing result.

At the end of season this format winners of the weekly shows get their 15 minutes of fame when they get to season finals where they do productions and other things in studio (live or taped). Basically these people could be anyone of the viewers who have done impeccable producing job—making entertaining iWiTTY clips and voting “recommended” on good clips, “pass” on second best set of clips and “rejected” on worst of the clips of their segment during the season and earned that spot. Also they have used successfully their phone, mobile or internet to vote and rate actual “THE” PRODUCER TV-Programs best and worst clips.

Similar programs without studio audience or even without studio can be done by simply just adding clip after clip with Avatar tail, which tells who made it and from which program (s) original footage is. Or then by using voice over, animations and other “jump to next” footage between clips broadcaster can make little more “hosted” type of programming. Programs can be also done easily in a small studio using “blue screen” (chrome key) background and running iWiTTY clips from competing viewers.

Programs can in future also be in full length “iWiTTY re-mastered” sitcoms or nature flicks or anything from any previously mentioned genres. To show viewers that they are currently watching re-cycled iWiTTY-version and not the original version of the program, there will be iWiTTY logo in one of the corners of the TV-screen (or it will pop up every few minutes) when this kind of programming is on the air. This way viewer won't mistakenly believe or mix it with the original version of the program. Full length programs edited this way can be done for example by invitation to certain individuals or groups.

Why make new, similar kind of programs and spend tons of money to programming which have been done over and over again already when you can just revive good or bad old ones by recycling and making them fin and different over and over again? When people have seen it all already in Movies, TV and bought either VHS- or DVD or downloaded it to a computer, iWiTTY TV's and iWiTTY Games' idea is to let viewers and selective groups (directors, teachers, executives, celebrities, producers, police officers, etc.) truly take control over TV and let them show their visions and creativeness and re-do what is done already one way. Remakes, “new kind of Director's cuts” can be lot more fun than originals and for sure are discussion, merchandise and re-run openers for tons of footage, programs and films dusting out in libraries.

Companies and people who own licenses or rights could sell any material or footage for this new re-cycle purpose and they can easily make lots of additional income by reviving already half buried (inter=bury, put into ground) programming. In the beginning programs or material offered for iWiTTY TV remakes will be surely less popular among license holders. But once results are viewed and new, entertaining programs are born and made, acceptance will increase more and more. And main reason for this is that audience will love to get their hands on something like this and will demand better programs for iWiTTY purposes.

More material will be cleared for iwitting purpose and by the beginning of the decade there's going to be C-, B-, even some A-Class movie releases and fairly well succeeded sitcoms and other top picks for people to remake. By the middle of next decade every new TV-program is probably done with “iWiTTY clause” in it. After all, money is what moves mountains and those who can see “the future of TV”-advantage in the beginning of this New Concept, will surely make most of it. Artists always love their art work but when there's option to make some extra, gain some air time or statue, these values are often forgotten. Music has proven what happens to newly revived, modernized songs. Often they become hits but also bring the good old original songs back to play lists.

All this footage that has been filmed, pictures taken, cartoons made or videos shot during the past 100 years (and have been or will be digitalized) or so in dozens of different countries, which lays useless in piles dusting, are just waiting for Next Generation to use their artistic views, creativeness, skills and wittiness to come up with new visions and outcomes, new type of entertainment and -education without shooting, producing, acting and doing sets for these purposes all over again and therefore saving in energy, traveling, material and at the end—saving our environment.

iWiTTY Concept goes with dozens of different kind of formats and mixes great with other TV-Concepts. You can create Game Show-, Talk Show, Comedy Clip-, Sport-, Nature-, Educational-, Sitcom-, Cartoon-, Drama-, Soup-, Documentary-, Feature Movie-, Reality TV- and Horror clips to fill full 30 minute or up to two hour programs based on iWiTTY TV Concept Formula.

iWiTTY Software can always be downloadable. It is for sale as iWiTTY Games in different price levels and can be for free in various places for educational purposes and has to be naturally cleared for iWiTTY TV and its type of programming use by who ever produces iWiTTY Games and -software. This is going to be the biggest hurdle in iWiTTY TV's way for getting massively big right away after launch. When necessary software is done and first programs are out in the future, this problem will be solved. General iWiTTY license agreements will enter the market and by the end of the next decade I can see iWiTTY TV as the biggest form of TV-Entertainment—World Wide.

Main safety feature is that if the footage isn't on mainframe, it won't accept this material sent by a player and this way not just any footage can end up in iWiTTY programs. Only iWiTTY cleared and licensed footage can this way be broadcasted. If it reads that material is not legally licensed, meaning that it isn't on mainframe, it will deny user access and stop downloading data.

Other level of iWiTTY programs can be that they are only viewable via mobile phones or via internet on iWiTTY TV websites with lower quality. Then later you can shop for “best of the” DVD as a higher quality product. This option will be even easier and cheaper to produce since you don't need studios or personnel, but basically only auto AMET (1.B) which can mix and make programs from clips automatically or then just basic editing tools. Then Company buys mainframe service for “upgraded footage”. This way small TV-station can for example view clips that are made (or let viewers or AMET (1.B), which can pick highest ranked clips that didn't make the cut to be broadcasted, do it) do this part) and pick only certain type of programming or -clips and pay by the higher quality programs that they order for broadcast instead of all the material created. This enables local channels in some areas with other kind of sense of humor or -taste to produce more localized programming. This way any Individual, Corporation, TV-Station or -Channel that owns footage library with all the rights, can become iWiTTY DVD- and Program Distributor and broadcaster almost over night. This is likely when iWiTTY System, Method and its services become more affordable.

When people start to buy hundreds of gigabyte harddiscs, they can buy “home kit” version of iWiTTY TV software. They can set up to their own web server where they can run their own “mini iWiTTY programs” which they can then sell to the public via their own channels. I can see lots of underground and cult classics being born after and if “iWiTTY TV home kit” comes available.

Sample 2: Player A buys an “iWiTTY Home Kit” software package for US 300 which includes footage from ten B-rated movies and license to use them as A pleases within iWiTTY license rules. Now A can use this material to produce programs for web cast and make DVD's for sale. But with so many people buying this same material A uses his own library in addition to this B-movie library which consists of various home parties and funny summer videos. Maybe even few home made films A produced, which never made it to Hollywood.

By putting all this material in server A calls for people to come and make their “best of the worst”. Let's say A collects at the end 100 clips. A picks 40 most entertaining of them, makes a master and starts burning DVD's which A then sells under Company's name on website to everyone who participated “competition”, friends and other web visitors or whatever marketing ways A finds and creates. This material could not end up in TV or other legal broadcasts because it has A's own material in it and it doesn't have necessary license for do it. Different license levels decide where what kind of iWiTTY programming can be aired and by whom.

Private Citizens have lots of footage they've shot and done that is fairly high quality and also very well could be broadcasted. This footage will need a market place to become iWiTTY material. In future there will be plenty of Footage Library companies that will buy and sell this kind of footage.

Sample 3: This material could be placed for sale for example under “iWiTTYtv.com/clip footage for sale” or in some other market place. Production companies, Library Owners, Broadcasters or Private Citizens that are doing iWiTTY productions, can place add that they are looking for certain type of material, footage. Or there could be Talk Show-, Radio-TV Show-, Game Show-, Entertainment-, News-, Sports-, Horror-, Drama-, Soup-, Sitcom-, Cartoon-, Animation-, Action-, Nature-, Kids-, Feature Film-, Music Video-, Reality TV- and iWiTTY TV clip market place for each one of the genres. As a respond they will get described material, quality it's shot in, best sample with signed prove and certificate its shot and rights are fully owned by the player who is selling it. Other viewers can, once again, put this material in their favorite order.

Once a Production Company wants to buy a clip, they contact seller (half automated), ask for waiver and original material and pay for it going market price (higher rated-higher value). Viewers again will have chance to gain extra points for their Avatar. If clip is sold fast with high price—they gain more points, if clip slides out of lists or is not sold in certain time period—minus points. This will create clip stock marketplace and as mentioned, be part of the massive MMOG where everything viewer does affects their points, rankings. After clip is sold, it's disposed from selling lists and clip usage is up to the Production Company from there on. Sold clip could be moved for a week to a list, which shows clips sold during past seven days. This list is ranked by highest bids and even by top 10 people who among others voted (recommended) for this clip at the earliest stage. They would be the one's gaining most points.

Private people can speculate with iWiTTY clips, they can actually buy, sell and trade them. If for example they see something good outside the rankings with no bids, they could buy clip for minimum bid and after buying it, enter it again. If they have gained status for their Avatar, they could get lots of “status”-extra and clip could end up highly ranked once they enter second time with this same material. Selling or buying clips will not gain points for players MMOG. Sold clips can end up in TV-programs only after they've been placed in one of “trade” iWiTTY- or similar mainframe/server computers that have these original iWiTTY clips in them. This is when mainframe holder takes part of the responsibility of clips legal liabilities.

Here is a sample list of iWiTTY programming genres that will run in future either in specific iWiTTY Channels or in any type of channels as part of the programming or as web cast's, mobile cast's or can be sold as DVD's or other digital formats or sold as downloadable “iWiTTY” programs “Powered by Viewers”:

iWiTTY-Talk Show-, -TV Radio-, -Game Show, -Entertainment, -News-, -Sports, -Horror, -Drama, -Soup, -Sitcom, -Cartoon, -Animation, -Action, -Nature, -Kids, -Feature Film, -Music TV, -Reality TV and iWiTTY TV programming.

Here is a list of what kind of new TV-program formats or Concepts its possible to make by using iWiTTY Concept, -clips and -technology and mixing it with Old and upcoming Concepts;

iWiTTY Talk Show Sample; Viewers' material can be bought as a iWiTTY Game or downloaded branded as iWiTTY Game “Talk Show with Pekka Kossila”. This iWiTTY Game consists of cleared footage (videos/stills) of celebrities, politicians, actors, athletes, historical people, criminals, various animals or short cartoon (or any of the underneath mentioned category) clips. Historical events-, sport moments—basically any file footage under different categories.

“News room”, which is where “player” writes daily jokes, makes and re-writes newspaper headlines, -stories, -TOP lists, -mortuaries, -movie adds, or any other adds for that matter, -classifieds, -cartoons, -stickers, -postcards, -letters, -brochures, -stamps, -faxes, -telexes, -stocks and -posters, video-, book-, product-, CD-, DVD-, LP- or Single covers and other print footage. All original (blanks) data is in mainframe computer to confirm that material used is legal (written text is always other matter), shortening uploading time and upgrading all the possible parts for the broadcast of the sent, redesigned footage. Open number (could be anything between 1.000-1.000.000) of “Viewer Producers” uses 10-30 minutes daily to complete their viewing and rating duties; Recommend-, Pass-, Rejected to gain advanced “Talk Show with Pekka Kossila” Producer rankings. To gain position as one of these “Viewer Producers”, people will have to participate actively and send some new entertaining material and get recommendations. Non-“Viewer Producers” can only send material but can not do the choosing part until they get to for example in rankings to top 100.000. Higher “Viewer Producers” get to make more important decisions with lesser clips to choose from, but if their recommendations are totally rejected, they will drop in “Producer” ladder as everyone else.

iWiTTY Talk show format can be fully done by players/viewers/“producers”. Final stream of each above mentioned best and funniest footage ends to “Talk Show with Pekka Kossila” program. Producers which/who then pick the best of the best for that nights show. Talk show can follow the same format every night or jump and use few of the themes during each of the nights. Without guests and audience this product can be done in the smallest of the studios by smaller broadcasters. With guests, music and audience clips can be added to the show in which ever suitable order. Talk Show can be done also without studio. There's just a virtual animated person in “virtual studio or space” and these clips are then added into the show as clip reels. Many radio hosts could (let production company do) do animated-virtual studio and use their personality as a host in this space and host these shows almost like they do in their radio shows commenting clips on the way.

iWiTTY TV-Radio Sample; or Radio-TV. Radio station builds a “blue screen” around radio studio. Host wears a blue screen suit and “blue painted” face. Host character can be morphed (using separate technology, this colored suit could wear any computer image made for this use, which is then shown on TV-screen) to look like an alien, monster or just funny looking character which ever option viewers have chosen or even created for that night. Several cameras shoot (Small studio, -channel can use steady cams) the host while he reads and comments iWiTTY material; headlines, daily jokes, newspaper headlines, stories, TOP lists, mortuaries, movie adds, or any other adds for that matter, classifieds, cartoons, stickers, postcards, letters, brochures, stamps, faxes, telexes, stocks, posters, video-, book-, product-, CD-, DVD-, LP- or Single covers (separated with video jingles) which TV audience can also see. Program Editor feeds the material and even changes camera angles, either virtual or real, from Control Unit (1.A) (CU). Radio-TV Host can play iWiTTY music videos (original music remains same), music for radio listeners and entertaining, newly styled music videos for TV-viewers or just latest regular music videos. This type of programming will bite especially for teens and youth alike. For even smaller budgets this show can be done without blue screen effects too using the same formula.

iWiTTY Game Show Sample; In separate iWiTTY TV programs internet and internet Cell Phone can be used in massive iWiTTY TV-Game Show/Quiz programs, where tens of thousands of players are logged in ‘Live’ program at the same time. From iWiTTY “Quiz Game Show” viewers send and select hardest, weirdest, funniest, shortest questions which they can selectively moderate if they have iWiTTY Game Show Game software at home. Then in a Live Show they try to answer these same questions on screen by pressing right options on their cell phone or by using PC or even Video Game Console with the Game.

“Who wants to be millionaire”-type of daily version downloaded to their Console or PC. People answer at home at the same time when the Studio competitor by playing the very game on their TV screens from their Console or Computer. Smaller screen shows competitor in studio and divided screen shows questions. When Studio Player drops out, game continues for the ones who make right choices until there's finale.

If they answer wrong they are dropped out from the line. If they make it within top 30 (or 10) they can win prices. Game goes on until there's only 2-3 competitors left and they are picked up to speak (if applicable) with the show's host. Then they will answer series of questions and who gets most right is the winner. These Quiz formats can also easily vary under different themes but the main thing is that every competitor is (at least most part of the season) participating from their home couch by making questions, viewing, recommending, passing or just participating this actual program by trying to get as far as possible. You can also add “who is fastest to answer a question” to end part of the show.

iWiTTY News Sample; This feature could be offered to news correspondents and bloggers around the globe. Old news footage is put on 1-4 (or series) iWiTTY “Games”. Footage is searchable by, location, city and country and under those terms they can find previously shot material from that area. They just edit necessary clips, do the voice over and instead of being in Baghdad, correspondent could be in Caribbean. All they need is “blue screen” travel mat and they can “clue” themselves in front of Eiffel tower or Coliseum as they were actually at the spot. Again, newsroom has all this material at their mainframe and downloading this material can be done fast, efficient and cheaply by one man instead of using cameraman-, editor- and other personnel and sending it expensively via satellite and other means.

This could easily multiply correspondents when you can use semi-amateurs-professionals. Also among footage they can find cleared footage (videos/stills) of celebrities, politicians, actors, athletes, historical people, criminals, various animals or short cartoon (or any of the mentioned category) clips. This footage can be also categorized to sports, politicians, celebrities, actors, events, winter, summer, fall and so on. Or then viewers just edit finny news iWiTTY clips from given material which is edited as a program.

iWiTTY Entertainment Sample; Lets pretend Saturday Night Live license rights holder wants and can do iWiTTY version from some of their older programs. They'll simply go through their programs and view which of their comedy clips could have been done otherwise, funnier, better or just differently. They digitalize these clips, make iWiTTY Game or downloadable version of it and advertise the product during their program. Before that they buy space and service from NBC (which could have this service) mainframe. NBC then buys best of these clips and airs them through the night time and along the season. They also sell best of iWiTTY Saturday Night Live DVD's for audience after they've been on the air or best of non aired ones. One other option is that they just select fellow comedians who they give iWiTTY clip options to re-do old “master pieces”.

iWiTTY Sports Sample; Goofy moments in sports can jump in to level “hilariously funny” when creative audience gets their hands on this material and starts adding human sounds, bubbles, comments from stock, animal sounds and other effects. These iWiTTY clips are then just simply broadcasted in a row.

iWiTTY Horror Sample; This material can easily turn in to comedy, parody or satire or then horror if it's the chosen iWiTTY TV-format. Who can do the scariest work can be the winner. Audience gets “The Game” and edits classics to new order to see if they can better the original work, make it scarier with the given materials and tools.

iWiTTY Drama Sample; Lets say Europe's 5 most popular actors want to join a co-production with America's Julia Roberts and Britain's Hugh Grant for a iWiTTY drama series. They shoot their mouth movements and tempers in Europe in front of their home studio location “blue screens” and afterwards material is collected and put together in Hollywood under iWiTTY Drama “Been Around” Game. But unlike in Animations where they only give their voice, they only give their appearance. Some other actors then read/act options to be dubbed on top of these “blank footages”. Players can use bubbles and other effects when each shot has long enough “tail” to fit one or more bubbles per shot. This drama then moves back and forth according to what viewers make out of it. It can be one season, one program (iWiTTY TV-Drama) or many seasons for that matter. When technology moves on, “players” could be able even to change clothes that actors are wearing. Again, actors and viewers can be in any part of the world to complete this task. With less popular faces there are no or fewer restrictions to what “players” can create from this material. Only sky is the limit.

iWiTTY Soup Sample; East L.A.'s criminal world is put in Beverly Hills. Most actors die within episode or two. But in this world resurrection is easy because if audience thinks actor/character needs to be revived, they just vote so and download new material with the character (for the character). This material can exist in stock (in mainframe) already but it becomes downloadable only if demand is heavy. At this point audience needs to create a way to bring these people back. End result surely can turn in to daily soup/comedy and production ways may vary from “blue screen” productions to regular set productions. With audience's involvement and improvising options again there's wide variety of new ways to make iWiTTY soup weather it's based on old- or new material.

iWiTTY Sitcom Sample; Producer decides (after licenses are negotiated) to send five different directors same full existing first episode of Friends from season one. These five directors have totally different taste so result is going to be five different programs. Audience can preview these via internet and the one with most votes gets viewing. Other four become collectables that could be sold as a DVD-collection. Next episode two has been sent to other 5 directors who then do their versions and so on.

Audience could make this same. By splitting the episode in short parts (30-60 clips) and then using iWiTTY TV formula putting it to full episode mode by using the best of the best short clips and putting together Friends episode one. These people would be participating “iWiTTY TV—Friends”-format and these results and game would (or can) be separate from other iWiTTY TV programs. Sitcoms could be done also same way as a mixed version of iWiTTY Drama or -Soup.

iWiTTY Cartoon Sample; Simplest iWiTTY version would be just to add and edit new comic bubbles, sounds, shouts, comments, lines, music, stills, murmurs, photos and various other effects to previously made cartoons. Cartoon strips could be used million times with new texts on them and just put music on the background and slide the funniest of them on the screen. This could be easily also part of Talk show or Kids programming. Political drawings/cartoons could be recycled in talk shows and as a part of Radio TV programs. iWiTTY Games can be also opening door for new artists/cartoonists who get their cartoon publicity and get thousands of writers (and lots of viewers) for their strips.

iWiTTY Animation Sample; Animations are most precious property and under rock to get re-cycled. There are tons of other animated clips in web space that can be bought, added to iWiTTY Animation Game and then again imagination will take care of funny and even funnier clips been born. This could be part of the program or separate hosted clip show.

iWiTTY Action Sample; Take regular action clips and mix them with iWiTTY Effects. Action gets more boost or funny curves depending on what is the purpose. This can be part of the program or separate hosted clip show.

iWiTTY Nature Sample; Just about any nature footage makes brilliant and funny clip program where audience makes iWiTTY effects to the nature clips and this show in full can be 30 or 60 minute program. Clips are just put in a row or in a hosted show. For example a thought bubble over ants head when it's moving a huge leaf opens basic idea.

iWiTTY Kids Sample; Kids could have their own creative iWiTTY Kids Game which includes heretofore parts and ideas that suit their creative minds the best. Best of the material is then aired in a hosted show or as a bulletin board type of program with just mixed iWiTTY clips.

iWiTTY Educational Sample; First you pick a subject and then you go shopping. There could be iWiTTY footage made especially for professionals/teachers that vary upon the subject. They can edit their own specific style program, add information bubbles and other effects to the footage and create interesting lessons for the kids or students by their terms. They can create/burn their own “library” for use during the term and use it then year after year. Narration they could either record or make every time they show it. Length and edutainment values are easily variable. Professionals could also use similar method to make programming from existing materials adding some new features and information, or their specific niche area of knowledge to some community projects.

iWiTTY info clips are more of a use in TV-formats. By using file footage and effects these info clips can be added to basically any hosted or un-hosted programs under anything: historic facts of survivors of the first airplane crash, yummiest Northern recipe's, police's top 10 commandments, why horse back riders hate snakes kind of weird or just edutainment (educational and entertaining) clips. Entertainment and educational value naturally varies upon programs purpose.

iWiTTY Feature Film Sample; Certain Directors get invitation and iWiTTY copy of “Traffic” The Movie and additionally all the unused, cut material. Directors make their own versions and actual Director Soddenberg then picks his favorite and this copy gets aired. This kind of programming is more likely at the later stage of iWiTTY formats future but with lesser successful films even earlier. Audience could get feature film trailers or some part of the movie to temper with. This can be good for some older- or flop movies which distributor and license rights holders want to revive. These clips can then be put under “Recycling Movies” or as a part of a movie review-, preview programs.

iWiTTY Music TV Sample; Radio TV sample goes well under this category as well. Real music videos mixed with iWiTTY music video and various iWiTTY clip program formats along the programming.

iWiTTY Reality TV Sample; Audience selects 10 celebrities (from pre-volunteered list) who will get a change to win 1.000.000 in donations for their favorite cause or just a million dollars. They get iWiTTY game in mail or they come to the studio, again, this can be any digitalized material and iWiTTY Game format (piece of sitcom, -horror, -drama, -movie, -still pictures or any selected footage) and they edit their own version of the clip or series program. TV cameras follow as they create and wonder around as they make their clip. At the end of the program celebrity's video is shown but after that there are also best clips from viewers competing against this celebrity. Who gets most votes advances.

These clips or programs can be shown via internet or solely as part of iWiTTY TV program or as in any of the future iWiTTY TV-formats in regular TV channels. These combinations are basically endless where audience, celebrities, directors, individual against individual, group against group and so on battle in different categories making as funny, entertaining, scary or educational stuff out of given materials.

So which ones of these sample program types are actual iWiTTY TV programs?
When programs carrying idea is to add iWiTTY element to it and programming crosses 50% line of the program.
When program footage is re-cycled and done by using iWiTTY tools (different name in a package doesn't make it something else) and formula.
When program is broadcasted and done by using iWiTTY formula and iWiTTY software.
When viewers are in charge of creating programming using iWiTTY technology, which means that they 1) get software, 2) produce clips, 3) view and review clips to filter best ones and then 4) clip data gets upgraded to broadcasting quality from lower quality.

### When connections get faster and home entertainment systems get more able to handle higher quality formats, part 4 might be unnecessary in later part of next decade but it will still be iwitting, recycling old data.

iWiTTY Concept “label” can be attached to any type of programming: Talk Show-, Radio TV Show-, Game Show-, Entertainment-, News-, Sports-, Horror-, Drama-, Soup-, Sitcom-, Cartoon-, Animation-, Action-, Nature-, Kids-, Feature Film-, Music Video- or Reality TV but it runs under just iWiTTY type of programming when there is a host or no host and all the material shown is edited, produced, written, directed and rated by viewers. Upgrading material to broadcasting quality is the last seal of an iWiTTY type of programming. Underneath I have three pure iWiTTY Concept formats. It breaks down every element of the Concept.

In-Depth Break Out of iWiTTY Concept Program Samples (3 Separate):

Target Audience:

“THE” PRODUCER—Families, Young professionals, College and University students, High school students, Adults, who play PC- or console games

DAILY PRODUCER—Young professionals, College and University students, High school students, Adults, who play PC- or console games

JUNIOR PRODUCER—College and University students, High school students, Middle school students, Elementary students

Suggested Time Slots:

“THE” PRODUCER—Weekend primetime, LIVE (or taped)

DAILY PRODUCER—Monday through Friday 4.00 pm.-7.00 pm, live (or taped)

JUNIOR PRODUCER—Tuesdays and Thursdays, around noon or 4 pm.-5 pm. taped

Length:

“THE” PRODUCER—60 min.

DAILY PRODUCER—30 min.

JUNIOR PRODUCER—30 min.

Logline:

So you think you can make entertaining programming! This is your chance to prove it! Make your own witty comedy clip and become real a life Hollywood Producer! “Can't win 'em so produce with them!”

Synopsis:

Individuals edit witty comedy clips and fight for the title of “THE” PRODUCER who will have to go through a tough battle against tens of thousands other producer wannabees and compete for the audience ratings and votes while managing their talent, taste, writing-, scheduling-, editing- and entertaining skills. Using witty footage libraries of various document-, sports-, news-, footage-, sitcom-, drama-, action-, adventure-, film- and other clips they add comic bubbles, sounds, shouts, comments, lines, music, stills, jitter burg', photos and various other effects to come up with crowd pleasing result. Winner of the season will get a change to prove his/her wittiness when he/she signs one year contract as “THE” PRODUCER with Paramount and receives minimum 500.000 dollars salary even by doing nothing. With maximum bonuses and productive work he/she can make up to 2 million dollars!

Detailed Synopsis “THE” PRODUCER Series:

New editing platform, -tool, -interface, -iWiTTY game will enable people to “remaster” various “license free”- and other clips. This platform is sold to new PlayStation 3, Xbox 360, Nintendo Revolution and PC-owners. They can buy iWiTTY Game DVD's with the tool, various footages and increase their library from variety of selection; “THE” PRODUCER: Sports, “THE” PRODUCER: Sports 2, “THE” PRODUCER: Documentaries, “THE” PRODUCER: Mixed clips and so on. Basically thinking, the more you have, the better chances you might have to become “THE” PRODUCER.

If they want a shot to win “THE” PRODUCER or “THE” JUNIOR PRODUCER title, they must register their product number to internet database using their own name, hometown and age. This also makes sure copies can not enter the program (one individual code accepted only per game). You got be 18 for participating DAILY PRODUCER and under 18 to participate JUNIOR PRODUCER at the time you register.

In the beginning players create their avatar and producer nickname and write down their real info. From there on every decision they make, clip they produce and enter, vote they give, clip they accept or reject will effect to their history becoming “THE” PRODUCER. The harder the material is to be produced funny, the higher multiplier score applies.

For example; “THE” PRODUCER: Historical Places multiplies your clips value (if it succeeds) five times compared to “THE” PRODUCER: Mixed. Highest multiplayer is 5, lowest multiplier 1. However, unsuccessful clip can be multiplied 5 times as well.

There are 11 levels in producing plus “THE” PRODUCER and “THE” JUNIOR PRODUCER which are the titles for the winners of the season. At any given time there's exactly 10.000 PRODUCERS (or higher) and 5000 JUNIOR producers (or higher) which opens the doors for making/choosing clips for the actual DAILY PRODUCER and JUNIOR PRODUCER programs from where you get be chosen to actual “THE” PRODUCER program. There's also an open door for all the clips that enter competitions, leaving that chance that you can actually become the winner without buying one product (if its the law).

Sample: By deadline 5 pm (broadcast next day at 5 pm.) there's 10.000 clips to be viewed (only producers or above can participate/max. one clip per day). Email alerts sent to 8000 producers that they have until 8 pm to view their 30 clips and rate them (10 recommended, 10 passed, 10 rejected). 1000 clips that receive most recommendations will advance to the next round.

Automatic emails will be sent to 2000 remaining, highest ranked producers at the time, explaining that they have 10 clips to view and rate by 9 clock the next morning (so they can reject, pass or recommend all clips in their power). 100 highest ranked clips will end up in hard disk- or tape form to production team.

Each Producer has 30 daily ratings to use, ten of each. (Must be “Producer” level or higher) and they can also earn (or lose) points by voting through phone, mobile, internet or digital receiver (?) when watching the “Live” program. If any material, that should have been censored, reaches top 100, it means big loss for all the “Producers” who recommended or passed the clip.

After daily (weekly) time layers of qualification, 100 best clips chosen by those producers (could be also 150, 250) who were doing their duties at the right time, are on production company's viewing room by 10 am., the actual production day' morning. By noon they have chosen the ones that will enter the program. Other formulas are easily possible.

Production team then chooses top 30 clips average 20 seconds per one (min. 10 seconds-max. 30 seconds) that are in put in no particular order. They also choose their top 3 comedy shorts which will be mixed in with other clips (as well as kept to reveal the winners at the end of the DAILY PRODUCER) so people vote randomly their favorites.

For each “THE” PRODUCER program, production team assistants search feasible clips (from any category) to be added to the show (lucky throw). Assistants can make an additional top 50 out of weekly clips from where production team chooses additional clips for “THE” program. This way you can reach out to be “THE” PRODUCER by just getting one witty game in your production library and doing constantly extremely good work.

Daily Producer:

Hosts, casual male and female in their late 20', early 30' with great chemistry, welcome viewers and introduce format casually in front of blue screen (bubbles and effects run on the background). They urge viewers who want to win one of the top three prices to call the number on the screen and get paper and pen to make notes. Mass multiplayer application allows viewers to stick online through the show cheaply (calls are diverted through internet) and vote for their favorites. Viewers use 0 to 9 rating 0 being the poorest and 9 greatest. To qualify for the prices or for “THE” PRODUCER (code asked) points, they must use/give each number three times.

First clip rolls in. After the clip, info rolls in (if it's from a sitcom, movie, drama . . . ), animated still of the clip's “producer”, his/her avatar and finally producer's nickname.

Second clip rolls in. This is repeated until clip number 10.

Hosts throw in a comment and “ . . . here's some more fresh productions!”.

Clips 11-20

Hosts commentary. Internet site reminder: www.iWiTTYtv.tv.

Commercial brake.

Host welcome viewers back, remind of the phone number.

Clips 20-30

Hosts comment: “Call now and give your ratings. You can see now quick review of the clips on the screen.”

Hosts are only shown very briefly. Voice over the phone will say; . . .

Shortened comedy scroll of all 30 clips starts running.

“ . . . the numbers one to 30 and you just press your phone, mobile phone touchpad or digital tv receiver's remote according to your opinion but remember that you can use each number from 0 to 9 only three times, not more not less. You have seven minutes to complete the task. If all the lines are busy you got to try your luck tomorrow. You can also give your ratings through our website if you have earned at least our “producer” title. More info can be found at iWiTTYtv.tv.”

Time counts down on the screen.

### Host reminds viewers of how to become “THE” PRODUCER, what the winner will get and what time the program comes.

Back to the studio. Clock counts.

### “When we come back you will see what are our own producer's top three selection and current producer ranking situation.”

Commercial brake.

Hosts are standing next to a Geek (jeans, smart shirt) who is sitting in front of giant computer flat screen and ask him detailed information about how many votes been given so far, which state has been most active and how many current producers have given their ratings.

Then they ask him to put on the screen current

“THE” PRODUCER Top 10.

After that Geek shows . . .

. . . avatars of who has done biggest down fall . . .

. . . and who has made biggest leap towards the top during past 24 (48) hours.

### Host: “And now here's what our production team chose as their top three.

### Third one is Harry LaFontaine (using real names), from Maine.”

Clip.

Back to hosts; “He will receive selection of “THE” PRODUCER DVD's.” In picture. “Includes . . . ”

“Production teams' second choice is . . . ”

Clip.

“Runner up will receive . . . (Cut to products)

. . . “THE” PRODUCER DVD's and five either pc, Xbox 360 or PlayStation 3 games of choice.”

“And our production teams favorite is this clip here . . . ”

Clip.

Around this point clock reaches zero.

“Max Mosley from Atlanta takes home either Xbox 360 or PlayStation 3 and previously seen games. All three will be seen in “THE” PRODUCER program on . . . (day) as will the viewers choices which we'll see after short brake. Voting has just ended so we'll also find out lucky viewer winners. Do we have double winners today? Stick around and find out.”

Commercial brake.

### (When viewer logs in after clock reaches zero, viewers have two minutes to finish their vote or otherwise it will not register)

### Hosts remind shortly of the website and how you can practice your talents and earn enough credibility there before stepping to the big Estrada.

“Third place winner . . . gets “THE” PRODUCER DVD's and five optional games.”

Clip.

### Second place . . . “Gets either XBOX 360 or PlayStation 3 so he is taking actually both machines home and 10 games and a PRODUCER DVD set as today's double winner.”

“And audience favorite today was this comedy short . . . ”

Clip.

“And as a winner of the DAILY PRODUCER . . . ” (Cut to product}

. . . “she will get a Scooter! She will also receive stack of games and PRODUCER DVD's and all today's six winners have a title . . . ”

“ . . . shot of becoming “THE” PRODUCER when they battle on . . . day.”

Lights dim as he still stands there. Credits start to run.

“I can't see a thing. Oh, flashlight, thanks. And we got a list of viewers that gave their highest scores, meaning their nine points to the winning trio. Computer has randomly printed out these lucky 3 winners.
Martha Kelly from New York and Seymour Heinz from Arkansas are our latest winners. They will all receive PlayStation 3 with two games.

### Congratulations to all winners and see you tomorrow.”

Credits start to roll. He waves, greets and walks away.

Fade out. End of program.

Junior Producer Outline:

Goes as above with next few changes.

Two younger hosts, maybe in early 20' or late teens. They are groovier.

Different blue screen background shows animations.

### Same Geek but in shorts, loose t-shirt and in general messier (he's the hosting glue, red string of

“THE” PRODUCER formats). Less valued awards given to the winners.

Taped show with advanced votes through internet. This determines winners and keeps parents happy though it also has production team's top 3 favorites. What keeps parents also happy is creative, non-violent, entertaining work kids do.

Voting and reviewing duties as less time accurate.

“THE” PRODUCER Outline:

Live show with the audience. Top Hollywood Executive Producer looking elderly man hosts the show. He “curses” his bad luck being selected as the “cover boy” of Hollywood and is trying to play tough cabinet guy, who's almost never seen the public and even more rarely smiled. His job is to mourn and whine and tell murky, funny stories about Top Hollywood Executive Producer's tough life, how he got there, how things were when he was young and so on. Walter Matthew in his 60' would have been excellent choice.

### He's got a beautiful sparkly assistant hostess who hangs around with our Geek (this time smart suit and combed hair) and takes generally over before any clips or info is put on the screen.

Show mixes twenty something combined producer's and production team's favorites from DAILY PRODUCER with additional clip pick's to make total of 40 clips. From JUNIOR PRODUCER comes top 10 or so plus additional picks to make total of 21 clips.

Junior Producer clips are run in groups of 7. Before brake all clips are shown.

Host.

Junior Producer 7 clips

Host comments.

Junior Producer 7 clips

Host comments.

Junior Producer 7 clips

Hostess:

“Time to vote. Give least favorites smaller number 2-4, mediocre ones 5 or 6 and top favorites between 7 and 9. You can give each number only three times.”

(Host, if taped version)

Commercial brake

After the brake, reminder of the JUNIOR PRODUCER clips.

Short reel with all 21 clips.

Host comments.

Hostess asks Geek info about voting.

Daily producer>10 clips.

Hostess reminds to vote your favorite Junior Producer clips and win one of the fancy prices.

(Host, if taped version)

Commercial brake

Host comments. Hostess tells that weekly Junior Producer will be known shortly.

Daily producer>10 clips

Host comments.

Daily producer>10 clips

Host comments shortly.

Hostess tells that Junior Producer voting has ended. Geek comments vote's volume.

“Before we look at the winners here's last 10 clips.”

Daily producer>10 clips

Host wisecracks something.

Commercial brake

Hostess tells that now is the last chance to get your numbers right. 0-3 to poorest, 4-6 to mediocre and 7-9 to those clips, that you think are the funniest. You must use each number four times. Voting for “THE” PRODUCER has started. So here's quick reminder of all the clips running for “THE” PRODUCER rewards.

Reel of 40 clips.

Hostess, “when we come back you'll see the winning Junior Producer clips.

(Host, if taped version)

Commercial brake

### Host wisecracks something about longer brake or . . .

Hostess reminds that there are few minutes to vote for “THE” PRODUCER. She goes through quickly the rules of the season how people can become either “THE” PRODUCER or “THE” JUNIOR PRODUCER. What winners of the season gets and “THE” PRODUCER'S possible future as a real time Hollywood producer.

Host has the results.

“Third place goes to . . . ”

Clip with additional real info of the player.

“Second . . . ”

Clip with additional real info of the player.

“And winner, this week's Junior Producer is . . . ”

Clip with additional real info of the player.

Hostess presents prices for the winners.

“Voting has ended and after the brake we'll see who is this weeks PRODUCER.

(Host, if taped version)

Commercial brake

Host wisecracks something.

Hostess is with Geek. He has data of the voting.

“Third place goes to . . . ”

Clip with additional real info of the player.

“Second . . . ”

Clip with additional real info of the player.

“And winner, this week's Junior Producer is . . . ”

Clip with additional real info of the player.

Hostess presents prices for the winners. Congratulates and reminds of the next show

Host waves and leaves stage. Turns back and says:

“Keep producing and we'll keep broadcasting.”

Reel of the witty clips.

(Winners one more time, if taped)

Fade out.

Taped “THE” PRODUCER International/Local Version:

You leave/cut out the interaction parts, where the Geek and hostess go through live shows info. Additional longer clip reel to the end of the show, few additional jokes by the host mixed in to the program. All formats can be done taped using studio audience voting system, or using web voting as the ultimate deadline. In “THE” PRODUCER you could also pick studio audience' favorite.

Season Finales:

Last 3 programs are 2-hour specials (no more Junior- or Daily Producer programs).

3×2 Hours “THE” JUNIOR PRODUCER

3×2 Hours “THE” PRODUCER

Ten computers set's (or consoles, which ever player chooses) and seats are placed in studio.

### In the first episode all the Junior Producer winners (10) battle to get in to top 5.

### They are given tasks.

1. What can they produce in 40 minutes with given materials.

2. How quickly take can produce any witty clip? Audience decides how funny it is.

3. Funniest clip, which they have produced prior to competition with no time limit.

First “THE” JUNIOR PRODUCER season finale program starts with short competitor presentation. Next the first task is given. While juniors jump in to the work further presentations on the competitors are done. They go deeper in to the junior's school background and life. Comments from parents, best friends or siblings are fit in the first sixty minutes. Camera jumps to the player doing live his/her new production.

When the first hour is finished, viewers have their favorites and after brake its time to view results of the first task. Viewers vote. Meanwhile juniors are given their second task. At the order they finish their task, their friend, parent or sibling will appear saying something short and funny about the junior player.

After maximum time limit (approximately 15 minutes) players who haven't finished, are eliminated. Voting is closing. Next its time to view results:

Clip produced on the spot, fast clip on the spot and funniest clip of the junior are all viewed in row.

“Which five will be here next week is now up to your voting. Audience's top three will advance to next week when “THE” JUNIOR PRODUCER will turn to Reality!” Also two other juniors chosen by our production team will be in this thrilling two-hour semifinal round. Voting ends on Tuesday so make sure you cast your vote by then.”

Who will be the first ever “THE” JUNIOR PRODUCER?

“THE” PRODUCER episode is similar competition for the adults. Used clips are more difficult. Who will be the first ever “THE” PRODUCER?

“Is this guy really so funny in nature as well? He produces quickly jokes, is he/she as witty at work, school also?” Program looks back how they made it to the top 5, “THE” (junior) PRODUCER history reel of each top five players. More in depth “Producer” interviews in the beginning of the semifinal show.

Last two 2 hour specials intensify and have more drama and also closer to real producing missions. Left open for the ideas of the director and producer. In the finals there will be 3 JUNIOR PRODUCER and 3 “THE” PRODUCER competitors left.

Production team's through the season favorite Witty clips reel. What will happen next year? Will you accept your new position? Next season starts from the beginning.

### “THE” PRODUCER Titles (Minimum Requirements)

| | |
|---|---|
| “THE” PRODUCER | Winner of the season |
| TOP EXEC. HOLLYWOOD PROD. | Season finalist or with at |
| | least all merits underneath. |
| EXEC. HOLLYWOOD PRODUCER | Winner of the weekly show, |
| | Winner of DAILY show, |
| | Winner of iWiTTYtv.tv |
| | show, collected at least |
| | XXX ratings, points with |
| | his clips, earned XXX |
| | points by choosing right |
| | winners, has produced |
| | successfully comedy clips in |
| | all multiplier levels (1 to 5), |
| | has kept consistency |
| | through out the season. |
| HOLLYWOOD PRODUCER | Winner of the weekly show |
| | or daily double winner. |
| TOP EXECUTIVE PRODUCER | Top 3 of the DAILY show, |
| | viewers choice or THE |
| | “Producer's” selective |
| | choices. |
| EXECUTIVE PRODUCER | Finalist of the DAILY show |
| | or in production teams top 3 |
| | choices. |
| PRODUCER | Earn enough ranking points, |
| | top 100-qualifier position of |
| | the DAILY PRODUCER |
| | TV show. |

At any given time there's no more or less than 10.000 producers. Once you have reached Executive Hollywood Producer title, you can become permanent member, who gets fewer duties but are in for a long haul. These players; Executive Hollywood Producer level and above, can come on top of the 10.000 (+ up to 500) producers because ultimately they are the once working hard.
ONLY they (producer and above) can rate the clips that will make it to the DAILY top 100. In smaller countries, different mathematical formula will be in use. Daily active producers count can vary greatly upon countries, but still player comes down quickly in rankings without participating.
Lower ranked Producers can step up in rankings by being in Top 3 in one of the iWiTTYtv.tv hourly competitions, voting and rating points or in Top 10 position of one of the iWiTTYtv.tv competitions. High level of recommendations by others and being ranked within top ten in one of the Wittytv.tv daily competitions, web broadcasts.

### Entering first comedy shorts and receiving first “recommended” from other producers or by receiving minimum amount of “recommended” points from others.

### Player gets first title after reading rules, making Avatar and signing in correctly.

| | |
|---|---|
| CREATIVE PRODUCER | Top 3 in one of the Witty |
| | TV.com hourly |
| | competitions. |
| CO-PRODUCER | Ranked at least once inside |
| | DAILY top 300. Enough |
| | voting and rating points. |
| | Top ten positions in one of |
| | the Wittytv.tv competitions. |
| | High level of |
| | recommendations by others |
| | XXX. |
| ASSISTANT PRODUCER | Ranked inside top ten in one |
| | of the Wittytv.tv daily |
| | competitions. |
| SECOND ASSISTANT PRODUCER | Entering first comedy shorts |
| | and receiving first |
| | “recommended” from other |
| | producers. Minimum |
| | amount of “recommended” |
| | XXX |
| PRODUCER TRAINEE | First title after reading rules, |
| | making avatar and signing |
| | in correctly. |

### Junior Producer Titles (as Previously with JUNIOR Word if Front)

### “THE” Junior Producer

I leave out the point counting (XXX) of “THE” PRODUCER because it would take too much away from the actual idea and space, it's more math's and logic and is probably in better hands with the future game makers cause X′, Z′ and Y′ can change several times before every block is in place. Its all part of the complete MMOG game, iWiTTY website and “THE” PRODUCER format participations and even maybe individual “THE” PRODUCER: “THE” iWiTTY Game, if so decided.

This was sample how formats are presented to the potential buyers in first or second phase. 3

iWiTTY examples that iWiTTY TV and its formats stand alone and with other Concepts.

### SUMMARY

There's one trend with the “old” media. It's declining success. Radio-, TV- and Film (Newspaper) sector are taking hits in ratings and numbers year after year. It's not that old media doesn't necessary work but industry and broadcasters are just feeding less interesting programs to this Next Generation population which has grown to multitask with New Media tools.

iWiTTY TV Concept gives any old material transformed in to digital form second change for TV-success. It revives viewer's interest level when they can actually put their hands on the programming. iWiTTY Concept can revive anything old and used; give it a new kind of entertainment value. It gives audience endless options to modify their old favorites and opens doors to underground digital world where everything can affect everything. It also opens doors to new exiting future, where audience truly takes control by creating, scripting, designing, editing, mailing, reviewing and either rejecting, passing or accepting TV-clips, even buying and selling TV-Programs by sculpting their own TV-World—literally. To cover this revolutionizing new way of producing TV-entertainment where people can create, buy, sell and trade video clips in virtual stock environment world needs a new word. If these new functions don't revive old media and its declining ratings, then you can truly say that it is doomed.

Interwitting will be the future of television because people want to do more, they want have more options, use their mind, creativity, sense of humor, artistic views and designs and surely be more involved, active and be partly in charge of TV-productions. Possibility to see own, family's, co-workers or friends production on TV is what guarantees iWiTTY TV's success. With all the simple software around us today, they can finally fully participate and compete, complete TV-programs or -clips and by upgrading them, make broadcast quality entertainment.

Broadcasting Companies and TV-Stations around the world will cash in all the savings they can make, Footage Licensor's and -Right Holders can see all the money they can make, Viewers can feel being respected and Nature will be consumed so much less.

iWiTTY TV Concept lays out road map for the Television for the next 20 years. Surely many of previously mentioned projections, visions will take a lot of time and effort to come true, but it's easier to create something big and new once you know where you are going and you have clear directions. Without this Concept, this very iWiTTY Utility Patent Application paper it would take years and years longer for the industry people to see that the future holds. And even longer time to come out with a straight forward strategy, where industry can clearly set certain license pricing, rules and regulations which can then later become industry standards.

License wall between old footage and rights can be broken. Its necessary to think how much of this wall anyone wants to break. The footage that has uncertain licensor's will remain in the pile dusting even after iWiTTY TV's launch. There's no reason to make all extra effort when you can have plentiful options from past two-three decades, where licensing facts are easier to dig up. And that certainly isn't buyer's headache. When iWiTTY clip market opens, it is sure there's going to be lots of dusting and cleaning happening in these cellars. Those dusted piles of footage can be turned in to clean piles of cash.

As of one Company getting license to something this huge, my opinion is that to receive best results this Company should spread the Concept as wide and as quickly as possible and through as many venues as possible once core is build. Holding back is like building a dam in front of thirsty villagers. Even the biggest of the Companies won't be able to handle all the demand and outcry once Concept is launched. To build full infrastructure surrounding the Concept is surely in better hands when it's done under leadership and control of this one Company, but since Television and its formats should be free for creative minds, monopoly strategy isn't a vice choice. Company who wants to create open market licensing method surrounding iWiTTY Concept is in my priority list.

### DRAWINGS

### How iWiTTY Clip Travels

First diagram indicates how clip footage streams become iWiTTY TV programming. Divided boxes and numbering indicates rough timeline, how this material ends up in a TV-Broadcast and what happens before, during and after clip ends up aired to TV-sets around country or world.
1. People and Companies who own full licensing rights to any footage sell trade and buy footage clips. This footage stream ends to market places and finally to TV-sets.
2. TV-Networks, TV-Stations, Production- and Game Companies, Footage Clip- and Investment Companies around the world buy trade and sell clips (their own libraries). To make iWiTTY TV-formats or iWiTTY programming, they need to acquire license from iWiTTY TV Concept Licensor. Once they have the license, they are able to produce and sell iWiTTY programming, make and sell iWiTTY Games according to the detailed agreement.
3. iWiTTY Concept Licensor chooses a Company to produce iWiTTY Editing Tool, core of iWiTTY Games, -Formats and -Concept. When it sells licenses, “blank” Editing Tool with all the basic effects is sold or given with the license package. This way users get familiar with it. iWiTTY Concept software can be sold to multitude electronic device platforms from mobile phones to PC's. Licensee can buy TV-format license from “shelf” or create own iWiTTY TV-format. They produce or buy additional footage and finish their iWiTTY Game for the market and put in on sale.
4. Players go and purchase iWiTTY game or download software to their devices. They choose the kind of “Game” which is dearest and start producing clips according to instructions. After this they send clips to website for others to view.
5. Viewers can't make their own clips successful without doing some reviewing of other viewers clips' first. Their whole iWiTTY program history is collected under their ID and when they are participating certain program, together with Avatar ID is also mentioning of their biggest success. “For no purchase necessary” reasons there can be the lucky throw change. These people can succeed by logging and signing in web and then using their taste, votes and put successful clips in right top order when they watch the program. New season gives refreshed start in some of the iWiTTY formats. Some formats can track player success and failures from the very beginning until full year (or years) is over.
6. iWiTTY websites will come effected by some heavy traffic that travels through and to it. They are clipboards for reviewing different iWiTTY Concept and -format clips. Site can run clip stock market place, it can make TV-heroes almost over night depending of a format and its also a place for small iWiTTY licensed TV-Stations who are looking for a cheap price; Readily available overflow material from Broadcaster who wishes to sell some of its great iWiTTY material it can not possibly broadcast or use otherwise (if license agreement allows this).
7. Mainframe keeps track of where and who buys and sells these clips, which clips they are thus keeping track of who will pay and get additional broadcasting- and license fees and from where, when time comes. Mainframe also makes sure that illegal material doesn't mix with the legally licensed iWiTTY TV clips while making sure that there are no security breaches. It is the HQ of all the legal material of any iWiTTY TV Channel or -programming Broadcaster. Mainframe computers with iWiTTY Original Footage Upgrade Software are most likely sold to major networks, some major production- and internet service provider companies around the world, which will each have different iWiTTY Clip libraries based on what they have licensed. Services can be provided by other companies as well.
8. What formats TV-Channel and Game- or/and Production Company agrees at stage 2 to produce and broadcast. This likely happens before buying license but this is also the venue where ready thought and made programs and formats are sold in the TV-Fairs around the world; Cannes, Hollywood, Hong Kong, etc. iWiTTY format ideas are sold and new programs are announced to the public through the media Mainframes act as smaller venues for these shows. There could be a digital showcase placed under main website of all the iWiTTY formats, who offers what, when and how available and downloadable presentations of these individual formats which can be then previewed prior to these fairs.
9. Production team gets its hands to the best of all the best edited clips and executes its iWiTTY TV-format according to the deal with the Broadcaster. With success, they can take their iWiTTY TV-format to sales venues or sell through iWiTTY TV website to smaller stations in their country. Sub deals to sell un-broadcasted clips will be registered and charged accordingly, if it's allowed in license agreement.
10. iWiTTY programming appears in TV-, Web- and Mobile broadcasts in different iWiTTY formats world wide. Country-, legal- and license restrictions, license agreements and general TV-program rules and regulations worldwide will keep pirate channels at bay to same extend as they do other programming. DVD's are made and sold by those who have licenses to do so and other byproducts and merchandise are born by the dozens. Viewers finally take real control of what they want to see. After all—they are the ones making programming.
   iWiTTY Tv Concept is Born from Streams of Witty, Entertaining Clips Made by Somewhat Witty or Creative People

### DETAILED DESCRIPTION

I have to remind at this stage that although I was creating the first iTV Channel in the world, I can't write a line of software. As a Producer I could describe my wishes to the Software Programmers and with Programming Director I spoke about bigger changes who then told Programmers what to do. I have presented the iWiTTY TV Concept to Paramount (VIACOM), Steve Freidman and his co-worker (I need to see Strategic Planning People they said) and Small World Company (How to get in to the Hollywood market) Tim Crescenti in the middle of September 2005 and revealing top secret Concept ideology to some Programming Director at this stage is not necessary very good idea just to get exact script how this is done. I just know that everything programming and technology wise in this Concept is doable today.

I will describe iWiTTY TV's production process as I would tell it to one of these Program Directors who would then turn description in to software code with teams' assistance:

iWiTTY Tv Licence Owner

After iWiTTY TV Concept license is sold, Major Company that has this license makes a decision to start to produce first iWiTTY TV programs. First it needs to decide what kind of iWiTTY TV-formats it will start to produce as priority products, which Company will make them and then they need to find footage. iWiTTY Library (will) consists of endless supply of clips and footage from the past in digital form that has ran on TV-screens long time ago or aired on TV during past decades. This library is the one they own.

Different iWiTTY TV-format Production Companies will have their own specific footage which is either fresh, made for the iWiTTY format or collected from the market for this specific iWiTTY TV-format use or provided by Licensee. When iWiTTY Concept grows, there will be specific demand for certain types of clips that should be on an iWiTTY “blank” Editing Tool or easily added in it. These “blanks” are sold to Production- and Game Companies. When they want additional material for this “blank”, they go through this iWiTTY Library and search for extras they want buy for their “blank”.

You can put this iWiTTY Library in three categories: One that you pay royalties upon the sale numbers, one which you have all the rights for and its “free” and then you have mixed ones. iWiTTY Library footage clips will surely have at least these three basic category pricing levels but in truth most popular ones are negotiated by the seconds used or copies sold or downloaded. Broadcaster naturally pays for material used in broadcast: Pay royalties, licenses, broadcasting fee>high price level, including sitcoms, series, films . . .

Some royalties, -licenses, broadcasting fee>medium price, sports, documentaries, drama, soups, b-class films and -series, regular programming footage from news etc. No royalties, one time license fee, additional broadcast fee low>low price, file-, location-, historical event-, privately owned and other mixed footage.

iWiTTY Clip process has to always include the Game use because without it, there's no production. License free (pay one time license fee) material can be searched through out the world after the first iWiTTY TV-format line up is in production. If for some reason Licensor doesn't have library to use, finding great archive shouldn't be hard, it's how footage, files are kept, registered, filed overall so that you can find what you are looking for. Anyway, Company most likely finds first material from their own footage library from where it's probably easiest to get green light. When Major Company has needed material, or while it's making it for the first iWiTTY TV-formats, it is time to create;

iWiTTY “Game”/-Interface/-Editing tool/-Software, /-Blank (production version)>for
Viewers: Players, Producers, Competitors, Game Users, iWiTTY Clip Producers>who use

Platforms: Video Game Consoles/PC's/Set Top Boxes-/DVR's-/TV's with hard disc>to make

iWiTTY TV Clips, iWiTTY Productions, iWiTTY Programs, Clips, Productions

There should be a way of doing very simple iWiTTY Editor Tool for digital TV receiver set top box even for a DVD player that record. Using combination; their current DVD player and high-end set-top with the networking capability and hard drive, digital video recorder (DVR) functionality, they should be able to do at least simpler editing. This would multiply user potential in no time and give fathers and mothers something to do. They wouldn't naturally be able to do as “cool” editing as PC- or Next Generation Console owners. Future TV's can handle this task too if they have hard disc. People just use remote to edit these clips.

iWiTTY TV Licensee or Licensor don't have to run after broadcasting details because mainframe keeps track of the Broadcast Quality Clips taken from it. When Broadcaster who has bought certain iWiTTY TV-format license has chosen the clips it wants to run on its daily show, wheatear its night-, morning-, day- or prime time should be marked in its contract, they mark and “open” the footage file to download iWiTTY clips' producer ID. Mainframe can track through all player files how much footage and which clips have been broadcasted by any certain Broadcaster and which parts of clip are under which broadcast license fee (Categories: High, Medium or Low . . . ). Surely Broadcaster does make a broadcast list, but this is backup check system. Players will surely keep track they get all the credits and points they deserve if their clips are broadcasted and this way Individual Broadcasters are liable to the audience that if clip is shown it's also marked as part of Daily Broadcast Report and rightful owners, Licensors will then get paid.

If they decide to make Best of DVD's, if allowed by agreement, or sell clips to other broadcasters, same method is used to mark these used clips. When iWiTTY Game is produced each clip is “earmarked” so that same information travels with them back to mainframe. This way iWiTTY clips rightful owners will always get their share by the fraction of a second if so stated.

Blank iWiTTY Editing Tool—Creation

Editing tool must have easy interface (user friendly outlook) so that in no time people can remake and edit footage. Players can add comic bubbles, sounds, shouts, comments, lines, music, stills, murmurs, photos and various other effects and elements to come up with crowd pleasing result. However, they must rely on given materials and cannot add their own footage or sounds. This way it's easy to prevent license mix ups. This option will come to the market somewhere at later stage of the Concepts life as a completely separate iWiTTY TV product line up, which will be carefully ruled and regulated.

Editing Tool will be at least in EASY, MEDIUM and HARD level. Everyone will have to go through the EASY level, before they can enter MEDIUM level which opens a lot more options and gives player the option to start participating iWiTTY TV programs. This way on EASY mode you can feed all the information needed for the hardcore players, whom never glances instructions. When you get to the MEDIUM level, you get access to internet and you can register in and start participating.

Firstly, EASY and MEDIUM Editor Tools should be easy to use for anyone interested in gaming or editing. Regular player shouldn't have to read nor view instruction booklet at all after going through EASY level. Everything is well categorized and subdivided. In general you start by choosing what you want to make, create: Headline, headline with a story, basic MEDIUM iWiTTY clip or HARD level iWiTTY clip. HARD level is Editor where player combines many video clips, uses tricks (cross fades, ripping picture . . . ) and combinations that could be hard for mainframe to do, understand without downloading the whole file. It has slower uploading times for player who uses this because video footage files would have to be uploaded fully to the mainframe. HARD level players have to prepare for longer waiting times.

Then you move on to the clip production. You look through main- and subcategories of clips until you find your idea (various editing programs and games that exists in the market, but none to my knowledge for this particular use). You're able to watch small still picture, or video clip on the screen of each still or video clip from library to give you quick idea what the material looks like. When you dive down the subcategories of the game you can pick material on the Game Clipboard to be exported to Video- or Media House. Media House has all the “print” material from Newspaper Headlines to Bumper stickers and will be added to second Editing Tool version.

After you've chosen your clips' or your Magazine, you move either to the Video- or Media House which has all print material and still footage. When you're in Video House, you can still go and fetch additional video files but not maybe as quickly and easily.

You open “project material”, Game Clipboard, which contains all the clips for your New iWiTTY clip. You place them in order in to the editing tool and then you can start adding other material or effects on top of it. Even thought all the footage is digitalized, all frames (1 frame is 1/24 second) of video footage are divided into additional horizontal and vertical lines. Each 16:9 widescreen frame is divided in to as many small “boxes” as sanely possible. About 3000 (less or more) boxes per frame should do just fine. Imagine 3000 invisible boxes on a additional digital layer on your TV-screen from which you can choose where you want to put your animated bubble's starting point for instance. This number will be decided upon what is user friendly. Information files of each of these video clip's frames' tiny boxes will be in the mainframe in original broadcast quality footage so when player sends iWiTTY clips, it can read and make effects in to right places. It's like a continuous digital mosquito net placed on top of all the iWiTTY footage that tracks down clip information by the frame.

1.) This video data does not have to be sent fully over the slow network but only be verified by the mainframe: From which part of the iWiTTY library Original Clips are been used? After mainframe reads Original Clip number 710, 3.5 seconds, from Original Clip timeline 00:00:01:00 to 00:01:04:12 and second clip number 1234, 6.0 seconds from Original Clip timeline 00:00:03:00 to 00:00:09:00 seconds mainframe just uses the Original material and starts adding, downloading other data on top of this. If people make more complicated (HARD) clips, this doesn't necessarily always apply because of multiple layers of data on same frame are not necessarily making sense without downloading whole video footage file.

When you move your cursor on top of the field (3000), unseen for the player, upon clicking opens options on the side of the of the screen (picture squeezes horizontally from the sides to give space). What kind of animated bubble, regular bubble or box you want to add there? Subcategories open. Others open upon players' choice. Little box underneath shows all the time this activated effect.

“Make your pick, (optional help box by the page, telling you additional info) where you want bubble?” Choose bubble type. After that, text editor appears on the side and font options are shown underneath.
After you choose your font, you write your text or you can finish that later. Then maybe you want to change color of the font, fill color or color of the bubble frame?

After you move on with your clip, you can always “rewind” to the same spot and just by clicking the bubble, box . . . , when you're in the Video House, just change the appearance, text, place, timing, colors or just delete it if you want.

2.) All this data about clip is gathered to “effects data soundtrack”. This is the new info that the mainframe needs when people upload iWiTTY clips to it. This way, once mainframe builds broadcast quality clip, it looks first data that matches original video footage in its memory. When it confirms this data is its memory, it reads “effects data soundtrack” on top of it for individual iWiTTY clip. This “effects data soundtrack” piece of information doesn't necessary require much space and therefore moves fast through the internet lines. If video data is not in the mainframe, it will simply not accept it.

For the sounds there's separate timeline that appears underneath video editing tool once you press “sounds” button. Original sound can be faded out totally, partly or removed (or it might not even be there because of licensing reasons). New sound effect boxes can easily be “dragged and dropped” to the timeline. By stretching them you make the sound or effect slower and vice versa. As in video clip editing, options appear on left side of the screen squeezing the picture in the tool.

You can add music to other soundtrack and mix them easily with the effects of your choice. How many channels are needed? Six is my guess for MEDIUM level editing. You can save your clip and show it to the “virtual audience” which will react with “boos' if there mixing flaws. The more flaws clip has, the harder boos it gets. If everything is flawless, “test audience” reacts with applause. It means that your witty clip is ready to enter iWiTTY TV competition through internet, to be sent and praised or shot down by other viewers and eventually be broadcasted via TV.

### 3.) All this info is gathered to separate “sound data soundtracks”, which is the new info that the mainframe needs to download fully.

Editor interface could come in to the market in three versions during 2-6 years. iWiTTY Games—products should be colored (silver, gold, and platinum) this in mind.

First (silver) version should be good at least. It should have plenty of everything from the effects list underneath. This version can lack slightly in performance because it's the first, fast produced version but as soon it's on the market, iWiTTY TV-formats can start airing. Editing interface itself has to be in its real future form already and even if appearance changes it's got have mostly everything in right places.

Second (gold) version should be very good with more exciting appearance, with wide variety of additional effects and sounds etc., with better and faster handling.

Third (platinum) editor should be The Excellent One that sticks in use for years to come. When viewers look at their library, they can immediately spot where which editor (silver is the one with least options, gold has less effects, sounds and platinum the most) was used. If there is only minor changes in between editing tools coming to the market, color could remain. These “blank” editor interfaces are then also sold for other iWiTTY Game producers. They will get certain amount of everything but they need to get their own video footage and certain other additional material to finish their own iWiTTY Game.

Later iWiTTY (gold) editor will have separate Video House and Media House when silver might not have Media House in it. In video House you edit video footage. In Media House you create “print material” footage clips. Ready made “print material clips” are brought to Video House for editing footage to video or just to place it to the time line. This way produced “headline” still picture can be any length player chooses to make it.

Effects Production

Animations: Wide variety of exploding, flying, crawling, running, disappearing, diving . . . objects that “the producers” can use as entry, outré or just as an additional effect in their product (for example the classical spinning newspaper, headline closes). These are produced mainly in-house although some of the material can be bought from the market.

Comic Bubbles: Animation houses that sell them with full rights, your own in house animation production, still artists. Thinking also unthinkable; squares triangles, flying objects, shapes, and vehicles, classic's . . .

Appearing Boxes: Different shape and size boxes which are commonly used. There should be wide range of color options. These you can simply fade in and out of your production. These should be made as in-house production.

Photos: Pictures of situations, people, buildings, happenings, paintings . . . basically of whatever when it's nicely and well categorized. Simply to buy large libraries for open use in all its forms unless Company has its own well managed one. Photos shouldn't be too much locked on any iWiTTY TV-format. Meaning SPORTS product should have wide range of photos outside sport segment leaving all the creative opportunities open for “the producer”.

Pictures: Again in-house library will be the best help. Also anything that can be bought in huge bulks cheaply; computer drawings, cartoon characters by amateurs, sketches, license free picks, others (STOP, TOP SECRET, DRIVE SLOW . . . ) anything that Company has all the rights for . . .

Stills: Any video footage that is good for taking a license free still out of it. Priority should be in-house library.

Newspaper FrontPages: In-house artists, -animators create wide variety of newspaper-, magazine-, comic book- and other front pages plus at least few other pages for each and additional “create your own page” for HARD level users. These prints are owned by imaginary iWiTTY Print Inc. Media House. Here people can create their own headline news and small fake stories, ads, classifieds, funeral lines, morphed pictures, TV-schedules, cartoons, postcards, stamps, stickers, letters, reviews and other fun print material for iWiTTY TV programs.

Music: What ever can be produced, bought and found or made in bulk on one fee basis.

Sounds: Using in-house license free library, or buying license free libraries for iWiTTY TV use with all the rights. Best way is probably to let team make new sound catalog from scratch. New range of sounds is good, since sounds on the market, same creaking cell door for example, are too widely used. Might take long time to produce but should be fully ready by the platinum version and is well worthy.

Jingles: Wide variation of jingles from all the decades, seasons, happenings . . . Made in-house; library and production. Could be found and bought cheaply from online market as well.

Shouts, Comments, Lines, Murmurs: Wide range of b- and d-actors give their voice to create a new, huge library which will never be completed. Few good imitators can make some classic lines and voices or just imitate famous people.

Other Effects: According to licenses and what can be found from in house libraries. One that really is funny is talking mouth, which you can move on top of any person, animal, character that's on the screen. It is the cheapest and funniest animation. You can make wide variety of mouths talking this and that and players edit a mouth clip on top of the iWiTTY clip. They could burp, laugh, cry, argue, smile, look angry, be disappointed or devastated or just crack short shouts and comments. There can be also hand-, foot-, hair-, mustache-, ear-, eye-, teeth-, jaw and some other masks that player then places, edits on top of the iWiTTY clip faces.

More Stills: On still side you can have wide variety of clothes, hats, shoes and other props. Or you can have drawn cars, houses, buildings, statues, ads, food, etc. shot in front of the blue screen, shot the old way or animated ones. These little effects can be edited easiest to iWiTTY clips, where you have motionless video footage of any situation.

In general iWiTTY clips can be any length Producer of the iWiTTY TV program wishes. In certain formats length really doesn't matter as long as the end product is funny and entertaining.

Those with fewer skills and less creativity might want to stick with shorter clips because they are easier to make. Longer clips don't necessary mean any more points than short ones (10 s versus 30 s) success wisely. It is how far player advances, succeeds in this iWiTTY entertainment pyramid. Top producers gain more credits and bottoms ones get on minus side thus falling in rankings. Those who join in the iWiTTY MMOG in the middle of the season or don't really care to join it, can just send “independent” iWiTTY Clips to programs but they fill have to fill in information, questionnaire form each time, which isn't that attractive necessary. Now Player has logged to iWiTTYtv.tv to get production on the air there are variety of options:

iWiTTY Tv Website and Player Id, Tracking Information

How website is done, what it looks likes isn't as vital to iWiTTY Concept as what's in it, what are the Next Generation features to gain advantage to predecessor TV Concepts, regular Video- and PC Games and how to create new kind of TV programming Powered by Viewers. What kind of services and options iWiTTY website offers is explained here:

iWiTTY TV website (s) is crucial element in iWiTTY TV Concept. It works as a filter to actual iWiTTY TV programming. One site could handle most of the traffic in Continent if Server-Mainframe has enough capacity. This will however probably create problems so in future there will be servers and mainframes in every corner of the world.

Player chooses firstly participating country for iWiTTY TV Concept programming. First timers register all their information; Name, address, county, zip code, phone- and cell numbers, age, gender. Then they create their Avatar animation. This is something player creates when she/he enters the iWiTTY World on the internet for the first time and it's something player can come and edit at any time. Avatar program allows player to choose from thousands of changeable faces, upload their own creations, real photos or create animated ones. Avatar viewer has nickname, images, “background” story that player writes which can be imaginary story mixed to factual Avatar character or then just real life short story.

Avatars' biggest credits (winner, 2^{nd} 3^{rd} of . . . ) will be automatically updated by the mainframe. Once Avatar creation is ready, program creates player iWiTTY TV “Identification card”. This ID is something that is shown in iWiTTY TV program reels after the program, after the individual clip, in certain programs as player introduction (Like in sport programs, when Player is presented) or used in rankings shown in TV-, Web- or Mobile broadcasts. This information is fun to watch, fun to create and is players', mainframes' and license holder's tracking “device” through out iWiTTY TV world. Player can choose from list, which programs he/she wishes to participate with each individual ID. They can choose from list: iWiTTY-Talk Show-, -Radio TV Show, -Game Show, -Entertainment, -News-, -Sports, -Horror, -Drama, -Soup, -Sitcom, -Cartoon, -Animation, -Science, -Action, -Nature, -Kids, -Feature Film, -Music TV, -Reality TV or plain iWiTTY programming according to which ever programs are running in their Country or area participant is playing from.

There are several ways how this tracking goes. Individual iWiTTY TV program ID tracks information from just that certain program. It gathers data of players' activity; how often player has been participating, if and when player has participated via internet mobile or regular phone to the show and ranks and success ratio from these different sessions, how many points (plus or minus) each session has created, which days rank above average player and which are under, best overall ranked days, advancement in rankings contra participating players—basically everything. From this data there is possibility to view daily-, weekly, monthly and yearly progress sheet in chart form.

Other ID tracking connects all the chosen iWiTTY TV-formats of one TV Channel or Network in a bigger localized or national game which can run through a certain time period, a week, a month a season or a year. After time period, these results are reset and everyone starts again from the scratch and this way everyone gets equal chance for success.

iWiTTY Online Game tracking can be part of either above options or completely separate world. This is where players play Local, National or Global iWiTTY Online Game. Games are based on the iWiTTY TV Concept but are played via internet using PC's and Next Generation Video Game Consoles. As in iWiTTY TV Concept player tries to do funny clips and different kind of programming which then others recommend, pass or reject. These results are not mixed with iWiTTY TV ranks, points or history. They can last only minutes, hours, days or weeks depending of the servers they connect with their ID's. So when player wants to play just one individual iWiTTY TV Game with his pals from other side of the world, they connect to the website to play online iWiTTY PC Game or iWiTTY Console Game. When there is a short time limit, everyone must work quickly and basic rules of iWiTTY TV apply; funniest will be most successful. Clips' producers are revealed only after other players have reviewed and given their ratings for them so that successful players are not “downplayed”. Player can choose to save these clips to his/her Avatar library that holds certain amount of player's best clips.

For hardcore players there's a MMOG (Massively Multiplayer Online Games) which connects all of the above data in to one huge iWiTTY MMOG game. Points and ranks are based on combination of progress both in real life iWiTTY TV Programs, cell-, web- and phone calls to program (s) and Online Games which includes all decisions made, activity contra right decisions and success in iWiTTY TV-, Internet- and Online iWiTTY Games. Separate MMOG banner on player's homepage gives them option to start to participate with MMOG when ever they wish to do so. Player can still hook with any individual iWiTTY TV program and have separate tracking credit coming for their ID instead of for MMOG ID.

Global iWiTTY TV is even more down the line in the future and opens wide variety of great iWiTTY TV-formats. It is a showcase for globally made iWiTTY TV clips. iWiTTY TV Clips are made according to iWiTTY TV-format as normally but people can participate from any iWiTTY TV programs broadcasting Country and its formats are hosted in local languages. In these formats iWiTTY clips made around the world compete on TV against each other (iWiTTY Voting System) but also Countries can be ranked according to success and compete this way. Tracking is done by mainframe which traces each participating player's ID on the web. It takes TOP ID's (10-100) from each country or top contenders up to TOP 1000 from different countries and adds their scores together and this is the Country's running score in rankings. Players who succeed in these Global iWiTTY TV-formats are up for some really nice prices and their final order, score is traced through iWiTTY TV website and according their ID's collected points.

All data mentioned above put together can add up to iWiTTY TV Player of The Year or ranked and chopped TOP lists in as many categories as reasonably ideal. Each player will also have their own clip library which consists of their productions. They can later download and modify again old productions with their PC, Video Game Console or other device.

When player gets ID email- or SMS alert, it comes with direct link to one of iWiTTY TV's screening rooms: iWiTTY-Talk Show-, -Radio TV Show, -Game Show, -Entertainment, -News-, -Sports, -Horror, -Drama, -Soup, -Sitcom, -Cartoon, -Animation, -Science, -Action, -Nature, -Kids, -Feature Film, -Music TV, -Reality TV or iWiTTY screening room. If player is in multiple competitions at the same time player can get several alerts per day (if TV-formats are daily shows) but in general they would get 1 or 2 alerts per week. First round of alerts goes to for example 4000 viewers. Player then completes task of viewing 30 or so clips and using 10 times Recommend, 10 times Pass and 10 times Rejected. Counter tells them all the time how many of which they've used. Player's task is to put TOP 10.000 clips in order and if participating, viewing rate is 50% that would mean that each of the TOP 10.000 clips get reviewed six times.

Same 30 clip block is sent to randomly to 12 players. After player enters screening room, there is a list of 30 clips. Each has three boxes and only after each clip is reviewed and box ticked and data is forwarded has player entered a “pending list”. This is completed once iWiTTY TV programs Production Assistant has finished and sent Daily Broadcast Report to mainframe. At this same time mainframe delivers points to players that completed their tasks. It counts points according to at what stage which clip was thrown out of the web TOP list and adds up total score. Players, who chose to “recommend” most of the clips that didn't make it to the next round, get minus points and vice versa.

Second alert is sent to next 4000 top players. Other 2000 viewers of them do the same, approximately 20 minute job between given time schedule and most Rejections gotten clips are again dropped. Most Recommended and Passed clip's advance and ID email alert is automatically sent to final 2000 players after certain time line closes (8 pm, 10 am, Tuesday at noon . . . ).

iWiTTY TV-formats highest ranked 2000 players then get ID email alert and their job is to narrow the given individual 30 clip lists to absolute Best of the Best. Actual iWiTTY TV program production Crew then views these clips and makes the program by upgrading their chosen iWiTTY clip list to Broadcast Quality in mainframe. Production Assistant marks used clips and makes Daily Broadcast Report which is sent to mainframe which delivers points to players and exact list of used clips to Licensor for book keeping and for license payments records. After the show is broadcasted, Production Assistant makes other list. This one reveals the final order of the winning clips (In some iWiTTY TV-formats). Player points are awarded accordingly.

Out of necessarily vital services iWiTTY TV Website will also have iWiTTY Clip Marketplace (described on page 9), TOP lists, Rankings, iWiTTY News based on topic and genre, player comments, iWiTTY Merchandising list, iWiTTY Web Magazine “Powered by Readers”, iWiTTY TV-format list detailing rules, regulations and how format goes, in which countries which format is currently running and other undetermined services and options.

Participating Via Internet or Internet Cellphone

Viewers who are watching TV can use internet or their internet mobile phones as remotes during any iWiTTY- or regular program with one cheap call during the whole show. When players log on to iWiTTY website for the first time they write down their different phone numbers. They are given Personal Code that they can use in several places. When they want to enter a competition with friend's phone but want to get the points for their account, they give this code. Only one of these lines can be activated at the same time (web or cell or phone or friends phone where they put the code) to avoid “cheating”. Now computer knows which user ID is using this phone number. Player does this to get more “credits” to his account. All decisions that viewer does during the program will then affect ID's account.

Viewer can also put this TV-Program' phone number in his phones fast dial memory so that next time he only presses number 1 and his speed dial puts him directly “in to the show”. Mainframe understands which player is calling once it recognizes number. If there's more than one player signed with the same number, mainframe always asks for the Personal Code for the verification of which user ID is active. If broadcasting station has Active iWiTTY Phone Software (WPS) running on the background of its programs, when it changes TV-program, this software follows and changes automatically accordingly. It can jump from iWiTTY Clip Show to iWiTTY Game Show. Software and viewers who want to continue using internet or their cell phone could just hang on the line without hanging up and calling to the number again or calling to some other number. Mainframe would automatically read that now same caller ID enters Game Show when TV program changes. WPS is done to follow TV programming on a Scheduler.

All decisions end up crediting or debiting user ID's accounts depending of which kind of account user has. When this happens in future, iWiTTY TV Channel viewer could call, log on in the morning show and hang up in the evening with one single low call price. Viewers can be asked when they lose a game if they want wait for the next program. If they choose to they just press button and keep listening advertising, info and music.

In certain formats points are credited according to prelist made in the mainframe by the program Producer. This could be even a pre-recorded show. Pre-recorded show with “Live” results through out the program is unheard of. If show hosts don't comment precisely on any results shown on screen, chart screens are just added to spots reserved for them according to the iWiTTY TV-format when it airs. Or then there could be 3 pre-taped versions of host's reaction after the results are shown and the one that fits best the results is broadcasted.

Sooner rather than later you'll be able to actually use your mobile phone and other devices that can communicate with your home PC to continue editing iWiTTY clips in a train, café or by the beach. Player contacts home PC with internet cell and gets “remote editing tool” open. This would be much lighter version of the actual editors and is mainly used for preview purposes. It will able previewing footage, choose clips to “mixing table” for further viewing, listen to sounds, music, lines and watch graphics, write memos and pick favorite effects so that when person gets pack to home, every previewed, added and accepted file waits for further processing. Using cell phone to produce (other than news footage) Prime Time TV-programming sounds far fetched, but as soon as software's are ready, this will be happening. And this is made possible by iWiTTY TV Concept.

Mainframe and -Server Functions

Mainframe for iWiTTY TV purposes has to be capable to handle massive amounts of data. Mainframe has several functions as the core of incoming iWiTTY clip' data. It holds all the original footage that is in each individual iWiTTY Game. Mainframe compares incoming data to what it holds in its memory, who is sending it, from which country, what kind of video files are in it, what is the additional new data including effects and sounds and makes sure senders region, video footage and effects are all from legal source. These are samples of the kind of security checks that licensors want and surely like. Someone buying iWiTTY Game illegally for example from Thailand is in for a surprise when trying to take part iWiTTY programming in some other country.

Firstly, only one person per game and individual code can access any one iWiTTY program or online gaming. Secondly, iWiTTY Games go by country. Which ever Country licenses iWiTTY TV-programming needs also a Game. Let's say Finnish Broadcasting Company (FBC) wants to use the one Game produced in USA and they want to use Mainframe that is located in London. Licensor sells them rights to sell Game (Even modify more localized Game with local soundtrack and extra features) and broadcast programming. Original material from Game is transferred to Mainframe in London if it was done in USA. People who buy this Game in Finland then register their Game to Mainframe in London, which could be the only Mainframe in Europe even with 40 some countries involved if it's database is massive enough. They are directed through broadcaster's website to log in to Finnish iWiTTY TV-program or -programs and therefore can not compete in other region TV-programs with this game. Mainframe would detect immediately that individual registered region is Finland. Thai version would not have right individual code to enter any regions' iWiTTY TV programming nor online gaming because it simply can't be registered.

When FBC then wants to see these best clips they simply log in with their access code, download DVD quality clips, review them, choose the ones they want and order download of the Broadcast Quality iWiTTY clips. Necessary data will be gathered and sent automatically. It reveals duration of each clip, who edited it and creators' Avatar in Broadcast mode, origin, date and so forth.

Besides all player ID logistics, Security and Original Video Footage Library upgrades, Mainframe communicates with Main Server which is the face of actual Mainframe for the users alike. Server has iWiTTY Country websites in it and millions of users coming and going through with their new iWiTTY clips. For Worldwide iWiTTY TV-formats these Mainframes and Main Servers are provided with all the data that they need to collect and verify. This data is then compared and put in order in mode of rankings or scores. Weekly globally broadcasted iWiTTY TV-formats are definitely going to be massive hits among Players, Viewers, Broadcasters, Game Producers and Licensors.

Main Server also collects different iWiTTY Game Winners from certain area' servers to participate live programming. This happens by patching winning individuals around the state (city, county, small country) to the iWiTTY Channel Broadcast which comes from Mainframe which has been scheduled by SS. Players who have iWiTTY Games at home will have various interesting TV-format options where home game's are mixed in with TV-programs.

Schedule (SS) (1.A)-, AMET (1.B)- and IPS Software (1.C)

When broadcaster wants to concentrate on smaller area but doesn't want to be dependable from other mainframes' services, option is to get Lighter Mainframe (less powerful computer) and Lighter Main Server to broadcasting facility and special software for their special purposes. SS—Schedule Software, AMET (1.B)—Auto Mixer Editing Tool Software and IPS—Individual Program Software has to be designed these needs in mind.

When Broadcaster wants to concentrate solely broadcasting iWiTTY footage there are options to choose from since iWiTTY programming comes in most TV-genres. Schedule Software has to make sure all this programming comes in timely manner. It has to be flexible enough to able last minute changes. Also it needs to be controlled by just one person to allow future “Home Channel” applications. This person can intervene live program feed by pressing button and speaking to microphone. This TV Channel DJ person can also add previously made graphic alerts on live feed. Schedules are made in advance but if there is a last minute change, DJ person should be able to choose new IPS or a program edited by AMET (1.B) and just drag and drop this digital file in to the preview time line which can be mixed to the broadcast timeline during the next coming commercial brake.

AMET (1.B) software mixes different TV-genre iWiTTY clips in to different length program blocks according to broadcasters' wishes. This could be overflow material from bigger broadcasters. AMET (1.B) gives this block info to mainframe which then provides necessary original footage for the individual program that AMET (1.B) has mixed. These individual program blocks are then placed to scheduler timeline waiting to be broadcasted.

If channel wants to mix Gaming-Gambling programming with “regular” iWiTTY programming, IPS files are placed on timeline. This then alerts Main Server to be prepared to get live players in to programming. In terrestrial-, cable- and digital satellite program broadcasts there's no lag (without FCC) or just fraction of a second and if channel can broadcast live programming without mandatory time delays, IPS programs can vary from action to gaming, racing to Free Cell depending what kind of interesting programming IPS Programmers and their Productions Companies can come up with. Individual IPS Game decides the number of players, how many can play the game at the same time and be seen. Most importantly—it decides whether it's interesting programming for the viewers to watch. Advantage of producing interesting, well done IPS Game programs is that software has to be done only once. Brilliantly executed IPS Game program software can last for years and be run for thousands of hours by multiple broadcasters around globe.

### Ramifications

iWiTTY TV Concept and iWiTTY TV-Program Production method will answer the question TV-Executives have been wondering long and hard: What's next? So what are the benefits and different uses of this invention? How TV-world will be better and more likeable place for Viewers, Video Game Players, TV-, Movie- and Video Game Producers, License Owners and any New Media-, old-, small- or big Broadcasters alike?
a) iWiTTY TV Concept cuts down TV-program production costs drastically by using mainly old; digital video or video-, film-, videogame- and still picture footage which is digitalized
b) iWiTTY TV-Production will be faster than any previous method because millions of people can make one program at once
c) Viewers, audience are the ones making the hardest, most time consuming part of the iWiTTY TV programs; creating, scripting, designing, editing, mailing, reviewing and either rejecting, passing or accepting them and basically deciding program content to the very highest level
d) iWiTTY TV makes it possible that New footage can be used to make endless New TV-Series from any given specific material; Soap-, Drama-, Sitcom- and Entertainment Programs
e) Generally any video- or film-footage or still picture works as well as the next one under different iWiTTY TV Concept or TV-formats
f) By using comic bubbles, sounds, shouts, comments, lines, music, stills, murmurs, photos and various other effects each viewer-player can produce one time creation, TV-production clip or program, which they can then later modify even through other devices
g) In iWiTTY TV Concept any footage that is given or sold to the audience/players is digitalized and can be upgraded to broadcast quality by the mainframe computer
h) iWiTTY TV allows New kind of fully- or semi automated 24/7 TV-Channels to take to air by letting viewers themselves to do most of the creative work—actual TV-programs
i) TV viewers can finally take control over TV programming by creating the kind of entertainment they really like and want to watch
j) Funniest clip after clip kind of entertainment will surely make people laugh which is the main factor of whole entertainment concept
k) Any designated group of people or single person can be chosen to make any requested type of programming from given material
l) Viewers, iWiTTY TV participants can make any length clips or programs
m) Players can download or buy any previous or new TV-program- or footage clips with iWiTTY editing tool and then design and publish their own creation for others to view
n) iWiTTY TV Concept can be mixed with Talk Show-, Radio TV-, Game Show-, Entertainment-, News-, Sports-, Horror-, Drama-, Soup-, Sitcom-, Cartoon-, Animation-, Action-, Nature-, Kids-, Feature Film-, Music Video- or Reality TV-Concepts and Productions
o) iWiTTY Games creates New Genre of Gaming by giving audience, “players” option to choose from PC- or Next Generation (Online option) Videogame Consoles either: Talk Show-, Radio TV Show-, Game Show-, Entertainment-, News-, Sports-, Horror-, Drama-, Soup-, Sitcom-, Cartoon-, Animation-, Action-, Nature-, Kids-, Feature Film-, Music Video- or Reality TV iWiTTY Game, which they can then modify, edit with iWiTTY editing tools
p) Each of above genre can be in individual iWiTTY Game TV-format, single TV-program format, whole season of TV-programs, Country TV-program format, Global TV-program format, Web cast Program-format or Mobile TV-format
q) Viewer will be able to use internet or internet mobile phones as a “remote” in various TV-formats through out the day and pay only fraction of regular phone call costs
r) Viewers can prepare “Prime Time” program clips even via internet cell phone
s) Viewers are able to review TV-program clips prior to broadcast and make producer level decisions of which clips should go and which should be in the TV-program
t) Viewer will be able to establish iWiTTY TV account on the internet which will gather all information, data and logs and create charts, keep clip library, production log of viewers' participation and success in various iWiTTY TV-programs or in iWiTTY MMOG
u) iWiTTY TV Massively Multiplayer Online Games (MMOG) will connect players' mobile-, internet-, TV-, PC- and Next Generation (Online) Videogame Consoles and other devices in to one big Game by collecting data from each source and ranking each player, group, city or country accordingly
v) Simple iWiTTY editing tool software can be downloaded to any device that has enough hard disc space, monitor or option to be hooked to a monitor or Television set or that has one (Set Top Boxes, DVR's, Home Music Centers, iPods, Mobile Phones, MP 3 players . . . )
w) When you don't have to do casting, set sets, hire people, buy or make new props and materials, move trucks, things and people or go to the nature to make a new TV-program, you will instead save it
x) Producers can save lots of money by producing iWiTTY TV programs in terms of saved time; by not having to go through all regular production levels and hiring all the people but instead of getting iWiTTY Game license and going through their existing footage library material to see what they can license or use to produce iWiTTY Game TV-formats
y) Any future or current broadcaster can set up automated iWiTTY TV-Channel with a very small staff and thus saving lots of money
z) iWiTTY clip programming is less expensive to broadcast that regular
aa) iWiTTY footage license holders will get all the information of their broadcasted, used material by fraction of the second from a round the world
bb) License holders can use iWiTTY TV forum to revitalize their dieing TV-formats, old useless footage, flopped movies, shows and series or sell, buy and trade footage with other License Holders, TV-Production Companies, Broadcasters and Market Speculators
cc) iWiTTY TV Concept Clips are fully copyright protected by clever mainframe which accepts only licensed material data and sees that unlicensed material will not be accepted and therefore end up mixed in any legal TV-Internet-, Mobile- or other future New Media broadcasts and this way protects license holder's rights
dd) Mainframe finishes players' video art work to broadcast quality
ee) Video data sent over internet can be just light video in video out information after which Mainframe adds and edits clips' video footage data itself from its original video footage files thus making it possible to send video files fast over the internet
ff) iWiTTY Concept will create exponentially new entertainment programs with reasonable costs

### Prior to Declaration

I have worked for and been part of the first Interactive TV creation in the world in Finland. Therefore I have overall knowledge and information of interactive TV procedures and applications of which I many partly or fully innovated.

My collaboration ended in September 1999 which in software life is ages ago. During the past six years I've had vision to create Next Generation TV Concept one day. When I saw one nature film while I was still working at Moon TV I had an epiphany that wouldn't it be funny if people could add a thought bubble on top of lion's head who was licking its lips and watching a impala on savannah saying something corny. Even more entertaining it would be to have many different versions to compare which is the funniest.

That is the very starting point of this Utility Patent Application. During the past 6 years I've lived in Asia and I've played lots of different games online and offline, seeing what kind of games people like, what kind of people play games, what makes them addicted, hearing their opinions about games, -playing and -creativity in general.

April 2005 after finishing a screenplay which had twist where one of the characters created a TV-format I had a vision that now it could actually be right time to put that bubble on top of that lions head—to combine TV and games.

Knowing that Next Generation Game Consoles are highly powerful mini computers with multitude software application options I started to visualize and script my visions. I also had realized earlier how easy it is to edit TV-programs, make brochures and other print work, web sites and even compose music by using computer which I had never thought I would learn in my lifetime. All these applications were suddenly so user friendly that I realized computer world had jumped to whole new level.

Since I'm not software programmer and I can't write a line of code, there was really no use for me to read any high tech publications related in this area.

Once I was starting my draft I realized that what I was writing is not Interactive TV but something else, new and much more creativeness and skills requiring Concept. My very first thought was iWiTTY. It just naturally popped in my mind. I'm witty. It was one of the very first things I had in my mind that this is something completely mind blowing and in future of TV that it can't be mixed with anything so miserably failed and old like Interactive TV.

All information in this application is based on solely my thoughts, overall knowledge, creativity, expectations, visions, ideas, especially logic and ability to handle and see the Big Picture in this area. I've just put together all the right pieces and surely there can be something I've missed somewhere along this massive work. Scrutiny should take care of that this Concept will get where it's going by its merits.

What I claim as my inventions are:

1. Method of producing television apparatus programming broadcasted via air and via cable comprising:

2. A software art work platform for television apparatus viewers comprising original television apparatus programming in lower digital form that in broadcasting quality and
a) wherein original digital footage comprising television apparatus programming that in the software is in a memory of the broadcast service computer

3. Digital video art work editing tool allowing television apparatus viewers to modify and manufacture original digital television apparatus and surrounding digital video art work programming
a) wherein downloadable software program art work and video game art work

4. Thus allowing television apparatus viewers to manufacture desirable digital television apparatus programming from digital video art work programming provided by software and by
a) wherein adding predetermined effects, sounds and graphics to be mixed to television apparatus viewers digital video art work

5. Sending lower that in digital broadcast quality programming for other television apparatus viewers and members via air and cable for reviewing and acceptance and
a). wherein digital video art work data amount is lower that in digital broadcast quality and will move faster via cable and via air and
b). wherein original digital television apparatus video program art work does not have to be fully launched via cable and via air thus original digital video art work is in a memory of a computer serving broadcaster
c). wherein television apparatus viewers digital video program art work video in and video out points are the information moved via air and cable and viewers video program art work is reconstructed by memory in computer with original digital broadcast quality of viewers digital video art work

6. Ranking the television apparatus programming in best of order by rejecting, passing and accepting viewers digital video art work,
a) wherein connecting to internet network artwork software the viewers block bad television apparatus programming

7. Thus allowing television apparatus programming production members to see the most likeable programming television apparatus respective viewers approve and
a) wherein production members get the viewers best digital art work for viewing b) wherein production members can make last decision of the program

8. Original digital broadcast quality television apparatus program software in a memory of computer manufactures digital broadcast quality television apparatus programming for broadcast from data modified, sent and approved by television apparatus viewers
a) wherein letting computer memory provide higher digital broadcast quality programming hereto digital video art work data manufactured by television apparatus viewers.
b) whereby making method unique concept in television apparatus programming

9. Television apparatus program concept, iwitty named type of witty method for producing television apparatus programming:

10. Providing original television apparatus art work programming in a digital video game art work software and downloadable art work software for digital platforms that television apparatus viewers can buy art work software and download the software and
a) wherein the viewers can choose from multitude television apparatus programs and the footage their favorite ones

11. Providing art work editing tool software together with digital television apparatus art work programming allowing viewers to modify and manufacture digital television apparatus programming
a) wherein artwork editing tool software surrounding software effects is provided to digital platforms

12. Requiring viewers to use wittiness and creativeness to manufacture and modify digital television apparatus programming art work in digital footage art work form that is lower that in original digital broadcasting quality art work to be broadcasted via air and via cable and
a) wherein the viewers use art work software in digital platforms to modify original digital video in software art work and
b) wherein the viewers modify digital effects to original digital video footage in software art work

13. Letting other viewers to approve the kind of digital video art work programming they want to manufacture and the kind of digital video art work programming they want to watch from television apparatus and
a) wherein giving the viewers awards for completing tasks and witty television apparatus program productions successfully to make the viewers rankings and keep the viewers interest in doing multitude tasks per gratitude and for possibility of future success and
b) wherein gathering this data from these tasks in to a computer memory and allowing television apparatus producer and the broadcaster to use this collected data in various awarding ways

14. Thus narrowing digital television apparatus program production members after art work to minimal and
a) wherein production team makes final programming decisions by watching only the best programming from the viewers

15. Letting a computer memory upgrade higher digital broadcast quality video art work programming data that of the viewers modified digital video art work from original digital video art work data in computer memory and
a) wherein a computer memory has all original broadcast quality digital video programming

16. Making it possible for the viewers to manufacture multitude number of digital video art work programs in lower digital quality level video art work for digital television apparatus broadcast quality programming form from lower than in original digital broadcasting quality level art work video and
b) wherein producer decides the material to be modified

17. Thus making digital television apparatus programming process means for unique iwitty television apparatus program entertainment concept

18. Method of combined automated digital radio apparatus and digital television apparatus broadcasting channel.

19. Heretofore iwitty television apparatus programming is processed with art work software in a memory of computer to make selected individual television apparatus programs by the program genre and
a) wherein the programs are created automatically by art work software dividing digital video art work from the viewers by the genre, length and success ratio of the viewers digital video art work
b) wherein television apparatus program heretofore digital video art work length is respectively from 5 seconds to multitude minutes including and excluding minutes per the program commercial messages
c) whereby choosing heretofore television apparatus programming suitable for radio apparatus listeners

20. Providing television apparatus programming for broadcasting computer memory and
a) wherein art work software schedules digital heretofore television apparatus program in respective order designed and commanded by broadcaster and
b) wherein heretofore television apparatus art work by the viewers suitable for radio apparatus programming is separated by the genre and
c) where in mixed to suitable digital art work computer data files to be broadcasted respectively by broadcasters command

21. Commanding digital television apparatus programming broadcast by individual art work software in computer data form to be previewed and broadcasted by the broadcaster and
a) within radio apparatus broadcaster can broadcast original lower digital level quality heretofore viewer television apparatus programming suitable at the same time for radio apparatus listeners and television apparatus viewers
b) within choosing lower level digital radio broadcasting format for radio apparatus broadcasts that in broadcast quality in digital television apparatus broadcasts
c) within radio apparatus broadcaster can broadcast heretofore upgraded original lower digital level quality heretofore the viewers television apparatus programming suitable at the same time for digital radio apparatus listeners and digital television apparatus viewers
d) Thus making it unique digital radio apparatus heretofore programming viewable in digital television apparatus method named Radio TV radio programming
